(19) United States
(12) Patent Application Publication
(10) Pub. No.: US 2025/0184872 A1
(43) Pub. Date: Jun. 5, 2025

(54) COMMUNICATION METHOD

(71) Applicant: KYOCERA Corporation, Kyoto (JP)

(72) Inventors: Masato FUJISHIRO, Yokohama-shi (JP); Henry CHANG, San Diego, CA (US); Amit KALHAN, San Diego, CA (US)

(73) Assignee: KYOCERA Corporation, Kyoto (JP)

(21) Appl. No.: 19/048,325

(22) Filed: Feb. 7, 2025

Related U.S. Application Data
(63) Continuation of application No. PCT/JP2023/028756, filed on Aug. 7, 2023.
(60) Provisional application No. 63/395,929, filed on Aug. 8, 2022.

(51) Int. Cl. H04W 48/10; H04B 7/06; H04W 48/02

(52) U.S. Cl. CPC H04W 48/10; H04B 7/06952; H04W 48/02

(57) ABSTRACT

A communication method for use in a mobile communication system includes forming, by a base station, multiple beams in one cell by beam sweeping, and when access restriction is targeted to only some of the multiple beams, broadcasting, by the base station, first information in the some of the multiple beams, the first information indicating that the access restriction is performed on a per beam basis.

### RELATED APPLICATIONS

The present application is a continuation based on PCT Application No. PCT/JP2023/028756, filed on Aug. 7, 2023, which claims the benefit of U.S. Provisional Patent Application No. 63/395,929 filed on Aug. 8, 2022. The content of which is incorporated by reference herein in their entirety.

### TECHNICAL FIELD

The present disclosure relates to a communication method used in a mobile communication system.

### BACKGROUND

In recent years, a mobile communication system of the fifth generation (5G) has been attracting attention. New Radio (NR), which is a radio access technology of the 5G system, allows broadband transmission via a high frequency band, as compared to Long Term Evolution (LTE), which is a fourth-generation radio access technology.

Since radio signals (radio waves) in the high frequency band such as a millimeter wave band or a terahertz wave band have high rectilinearity, a problem exists in that the coverage of a base station is reduced. In order to solve such a problem, a repeater apparatus has been attracting attention. The repeater apparatus is one type of relay apparatus for relaying radio signals between a base station and a user equipment, and is controllable from a network (see, for example, Non-Patent Document 1). Such a repeater apparatus can extend the coverage of the base station while keeping the interference from occurring by, for example, amplifying a radio signal received from the base station and transmitting the radio signal through directional transmission.

### CITATION LIST

### Non-Patent Literature

Non-Patent Document 1: 3GPP Contribution: RP-213700, “New SI: Study on NR Network-controlled Repeaters”

### SUMMARY

In a first aspect, a communication method is a communication method for use in a mobile communication system, the communication method including forming, by a base station, multiple beams in one cell by beam sweeping, and when access restriction is targeted to only some of the multiple beams, broadcasting, by the base station, first information in the some of the multiple beams, the first information indicating that the access restriction is performed on a per beam basis.

In a second aspect, a communication method is communication method for use in a mobile communication system, the communication method including controlling, by a first network node configured to manage a first cell, a relay apparatus configured to relay a radio signal between the first network node and a user equipment in the first cell, and communicating, by the first network node, control state information regarding a control state of the relay apparatus with a second network node configured to manage a second cell adjacent to the first cell.

### BRIEF DESCRIPTION OF THE DRAWINGS

FIG. 1 is a diagram illustrating a configuration of a mobile communication system according to an embodiment.

FIG. 2 is a diagram illustrating a configuration of a protocol stack of a radio interface of a user plane handling data.

FIG. 3 is a diagram illustrating a configuration of a protocol stack of a radio interface of a control plane handling signaling (control signal).

FIG. 4 is a diagram illustrating an example of an application scenario for a relay apparatus (NCR apparatus) according to a first embodiment.

FIG. 5 is a diagram illustrating an example of the application scenario for the relay apparatus (NCR apparatus) according to the first embodiment.

FIG. 6 is a diagram illustrating an example of a control method of the relay apparatus (NCR apparatus) according to the first embodiment.

FIG. 7 is a diagram illustrating a configuration example of a protocol stack in a mobile communication system that includes the relay apparatus (NCR apparatus) according to the first embodiment.

FIG. 8 is a diagram illustrating a configuration example of the relay apparatus (NCR apparatus) according to the first embodiment.

FIG. 9 is a diagram illustrating a configuration example of a base station (gNB) according to an embodiment.

FIG. 10 is a diagram illustrating an example of downlink signaling from the base station (gNB) to a control terminal (NCR-MT) according to the first embodiment.

FIG. 11 is a diagram illustrating an example of uplink signaling from the control terminal (NCR-MT) to the base station (gNB) according to the first embodiment.

FIG. 12 is a diagram illustrating an example of a general operation sequence of the mobile communication system according to the first embodiment.

FIG. 13 is a diagram for describing beam sweeping according to the first embodiment.

FIG. 14 is a diagram for describing beam unit access restriction according to an embodiment.

FIG. 15 is a diagram illustrating an example of the beam unit access restriction according to an embodiment.

FIG. 16 is a diagram illustrating an operation example of the gNB for the beam unit access restriction according to an embodiment.

FIG. 17 is a diagram illustrating an operation example of a UE for the beam unit access restriction according to an embodiment.

FIG. 18 is a diagram for describing a first operation example of an inter-cell cooperative operation according to an embodiment.

FIG. 19 is a diagram illustrating the first operation example of the inter-cell cooperative operation according to an embodiment.

FIG. 20 is a diagram for describing a second operation example of the inter-cell cooperative operation according to an embodiment.

FIG. 21 is a diagram illustrating the second operation example of the inter-cell cooperative operation according to an embodiment.

FIG. 22 is a diagram for describing a relay apparatus according to a second embodiment.

FIG. 23 is a diagram for describing the relay apparatus according to the second embodiment.

FIG. 24 is a diagram for describing an operation according to another embodiment.

FIG. 25 is a diagram illustrating a model of a network-controlled repeater.

FIG. 26 is a diagram illustrating a protocol stack focusing on a C-plane of the NCR-MT.

FIG. 27 is a diagram illustrating a multi-beam NCR.

FIG. 28 is a diagram illustrating options for a management model of a multi-beam repeater.

FIG. 29 is a diagram illustrating a CA/DC configuration of the NCR-MT.

### DESCRIPTION OF EMBODIMENTS

When a relay apparatus such as a repeater apparatus is controlled from a network, a control technique for specifically controlling the relay apparatus has not yet been established, and efficient coverage extension is currently difficult to perform using the relay apparatus.

The present disclosure provides an appropriately controllable relay apparatus that performs relay transmission between a base station and a user equipment.

A mobile communication system according to an embodiment is described with reference to the drawings. In the description of the drawings, the same or similar parts are denoted by the same or similar reference signs.

### (1) First Embodiment

A first embodiment is described first. The relay apparatus according to the first embodiment is a repeater apparatus that can be controlled from a network.

### (1.1) Mobile Communication System Overview

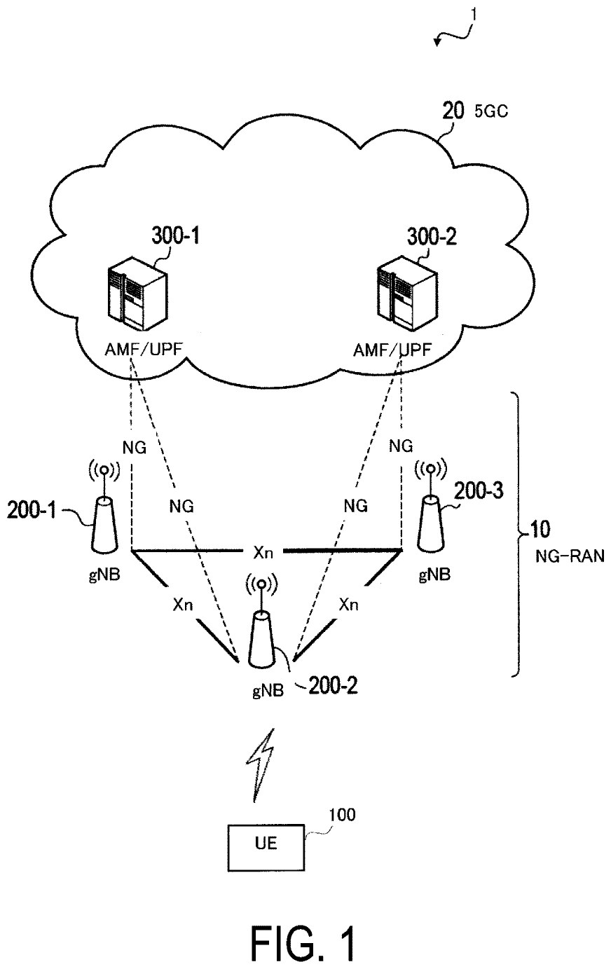

FIG. 1 is a diagram illustrating a configuration of a mobile communication system according to the first embodiment. A mobile communication system 1 complies with the 5th Generation System (5GS) of the 3rd Generation Partnership Project (3GPP) (registered trade name; the same applies below) standard. The description below takes the 5GS as an example, but Long Term Evolution (LTE) system may be at least partially applied to the mobile communication system. A sixth generation (6G) system may be at least partially applied to the mobile communication system.

The mobile communication system 1 includes a User Equipment (UE) 100, a 5G radio access network (Next Generation Radio Access Network (NG-RAN)) 10, and a 5G Core Network (5GC) 20. The NG-RAN 10 may be hereinafter simply referred to as a RAN 10. The 5GC 20 may be simply referred to as a core network (CN) 20.

The UE 100 is a mobile wireless communication apparatus. The UE 100 may be any apparatus as long as the UE 100 is used by a user. Examples of the UE 100 include a mobile phone terminal (including a smartphone) and/or a tablet terminal, a notebook PC, a communication module (including a communication card or a chipset), a sensor or an apparatus provided on a sensor, a vehicle or an apparatus provided on a vehicle (Vehicle UE), and a flying object or an apparatus provided on a flying object (Aerial UE).

The NG-RAN 10 includes base stations (referred to as “gNBs” in the 5G system) 200. The gNBs 200 are interconnected via an Xn interface which is an inter-base station interface. Each gNB 200 manages one or more cells. The gNB 200 performs wireless communication with the UE 100 that has established a connection to the cell of the gNB 200. The gNB 200 has a radio resource management (RRM) function, a function of routing user data (hereinafter simply referred to as “data”), a measurement control function for mobility control and scheduling, and the like. The “cell” is used as a term representing a minimum unit of a wireless communication area. The “cell” is also used as a term representing a function or a resource for performing wireless communication with the UE 100. One cell belongs to one carrier frequency (hereinafter simply referred to as one “frequency”).

The gNB 200 may be divided into a Central Unit (CU) and a Distributed Unit (DU). The CU controls the DU. The CU is a unit including upper layers included in a protocol stack described below, such as an RRC layer, an SDAP layer, and a PDCP layer, for example. The CU is connected to a core network via an NG interface which is a backhaul interface. The CU is connected to a neighboring base station via an Xn interface which is an inter-base station interface. The DU forms a cell. The DU 202 is a unit including lower layers included in the protocol stack described below, such as an RLC layer, a MAC layer, and a PHY layer, for example. The DU is connected to the CU via an F1 interface which is a fronthaul interface.

Note that the gNB can be connected to an Evolved Packet Core (EPC) corresponding to a core network of LTE. An LTE base station can also be connected to the 5GC. The LTE base station and the gNB can be connected via an inter-base station interface.

The 5GC 20 includes an Access and Mobility Management Function (AMF) and a User Plane Function (UPF) 300. The AMF performs various types of mobility controls and the like for the UE 100. The AMF manages mobility of the UE 100 by communicating with the UE 100 by using Non-Access Stratum (NAS) signaling. The UPF controls data transfer. The AMF and UPF are connected to the gNB 200 via an NG interface which is an interface between a base station and the core network.

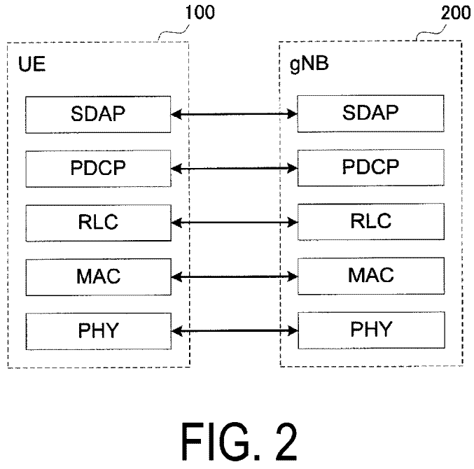

FIG. 2 is a diagram illustrating a configuration of a protocol stack of a radio interface of a user plane handling data.

A radio interface protocol of the user plane includes a physical (PHY) layer, a Medium Access Control (MAC) layer, a Radio Link Control (RLC) layer, a Packet Data Convergence Protocol (PDCP) layer, and a Service Data Adaptation Protocol (SDAP) layer.

The PHY layer performs coding and decoding, modulation and demodulation, antenna mapping and demapping, and resource mapping and demapping. Data and control information are transmitted between the PHY layer of the UE 100 and the PHY layer of the gNB 200 via a physical channel. Note that the PHY layer of the UE 100 receives downlink control information (DCI) transmitted from the gNB 200 over a physical downlink control channel (PDCCH). Specifically, the UE 100 performs blind decoding of the PDCCH using a radio network temporary identifier (RNTI) and acquires successfully decoded DCI as DCI addressed to the UE 100. The DCI transmitted from the gNB 200 is appended with CRC parity bits scrambled by the RNTI.

The gNB 200 transmits a synchronization signal block (SSB: Synchronization Signal/PBCH block). For example, the SSB includes four consecutive Orthogonal Frequency Division Multiplex (OFDM) symbols, in which a primary synchronization signal (PSS), a secondary synchronization signal (SSS), a physical broadcast channel (PBCH)/master information block (MIB), and a demodulation reference signal (DMRS) of the PBCH are arranged. A bandwidth of the SSB is, for example, a bandwidth of 240 consecutive subcarriers, that is, 20 RBs.

The MAC layer performs priority control of data, retransmission processing through hybrid ARQ (HARQ: Hybrid Automatic Repeat reQuest), a random access procedure, and the like. Data and control information are transmitted between the MAC layer of the UE 100 and the MAC layer of the gNB 200 via a transport channel. The MAC layer of the gNB 200 includes a scheduler. The scheduler decides transport formats (transport block sizes, Modulation and Coding Schemes (MCSs)) in the uplink and the downlink and resource blocks to be allocated to the UE 100.

The RLC layer transmits data to the RLC layer on the reception side by using functions of the MAC layer and the PHY layer. Data and control information are transmitted between the RLC layer of the UE 100 and the RLC layer of the gNB 200 via a logical channel.

The PDCP layer performs header compression/decompression, encryption/decryption, and the like.

The SDAP layer performs mapping between an IP flow as the unit of Quality of Service (QOS) control performed by a core network and a radio bearer as the unit of QoS control performed by an Access Stratum (AS). Note that, when the RAN is connected to the EPC, the SDAP need not be provided.

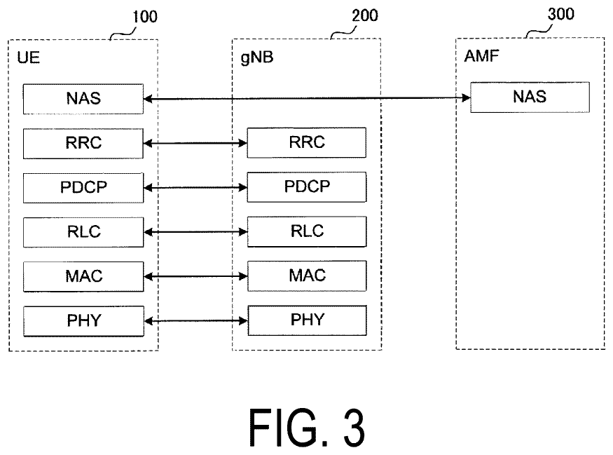

FIG. 3 is a diagram illustrating a configuration of a protocol stack of a radio interface of a control plane handling signaling (a control signal).

The protocol stack of the radio interface of the control plane includes a radio resource control (RRC) layer and a non-access stratum (NAS) layer instead of the SDAP layer illustrated in FIG. 2.

RRC signaling for various configurations is transmitted between the RRC layer of the UE 100 and the RRC layer of the gNB 200. The RRC layer controls a logical channel, a transport channel, and a physical channel according to establishment, re-establishment, and release of a radio bearer. When a connection (RRC connection) between the RRC of the UE 100 and the RRC of the gNB 200 is present, the UE 100 is in an RRC connected state. When no connection (RRC connection) between the RRC of the UE 100 and the RRC of the gNB 200 is present, the UE 100 is in an RRC idle state. When the connection between the RRC of the UE 100 and the RRC of the gNB 200 is suspended, the UE 100 is in an RRC inactive state.

The NAS layer which is positioned upper than the RRC layer performs session management, mobility management, and the like. NAS signaling is transmitted between the NAS layer of the UE 100 and the NAS layer of an AMF 300A. Note that the UE 100 includes an application layer other than the protocol of the radio interface. A layer lower than the NAS layer is referred to as an AS layer.

### (1.2) Example of Application Scenario for Relay Apparatus

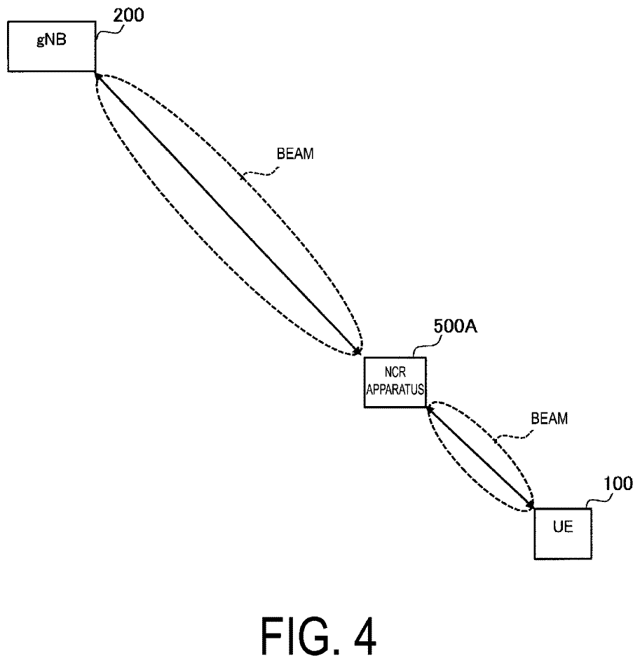

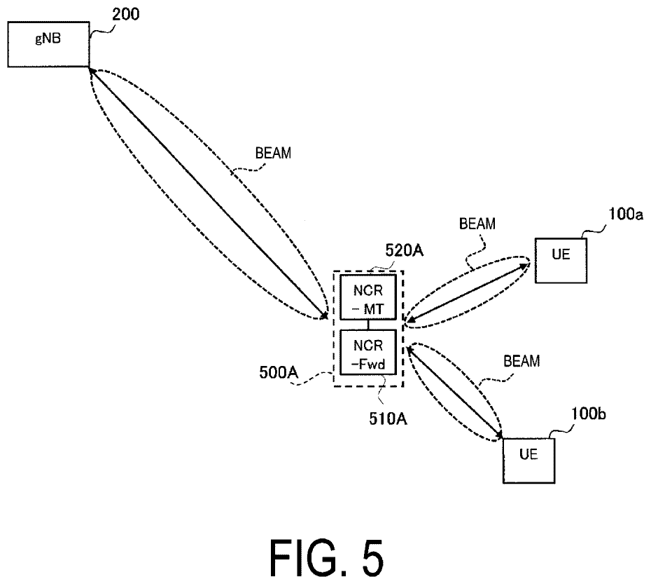

FIGS. 4 and 5 are diagrams illustrating examples of an application scenario for an NCR apparatus according to the first embodiment.

The 5G/NR is capable of wide-band transmission via a high frequency band compared to the 4G/LTE. Since radio signals in the high frequency band such as a millimeter wave band or a terahertz wave band have high rectilinearity, a problem is reduction of coverage of the gNB 200. In FIG. 4, a UE 100 may be located outside a coverage area of the gNB 200, for example, outside an area where the UE 100 can receive radio signals directly from the gNB 200. The UE 100 may be in a state where communication with the gNB 200 cannot be performed within a line of sight because of obstacles existing between the gNB 200 and the UE 100.

As illustrated in FIG. 4, a repeater apparatus (500A) is a type of a relay apparatus relaying radio signals between the gNB 200 and the UE 100, and can be controlled from the network. The repeater apparatus (500A) is introduced into the mobile communication system 1. Hereinafter, such a repeater apparatus is referred to as a Network-Controlled Repeater (NCR) apparatus. Such a repeater apparatus may be referred to as a smart repeater apparatus.

For example, the NCR apparatus 500A amplifies a radio signal (radio wave) received from the gNB 200 and transmits the radio signal through directional transmission. To be specific, the NCR apparatus 500A receives a radio signal transmitted by the gNB 200 through beamforming. The NCR apparatus 500A amplifies the received radio signal without demodulation/modulation and transmits the amplified radio signal through directional transmission. Here, the NCR apparatus 500A may transmit the radio signal with a fixed directivity (beam). The NCR apparatus 500A may transmit a radio signal with a variable (adaptive) directional beam. This can efficiently extend the coverage of the gNB 200. Although in the first embodiment, it is mainly assumed that the NCR apparatus 500A is applied to downlink communication from the gNB 200 to the UE 100, the NCR apparatus 500A can also be applied to uplink communication from the UE 100 to the gNB 200.

As illustrated in FIG. 5, a new UE (hereinafter referred to as an “NCR-Mobile termination (MT)”) 520A is introduced that is a type of a control terminal for controlling the NCR apparatus 500A. Specifically, the NCR apparatus 500A includes an NCR-Forward (Fwd) 510A and an NCR-MT 520A. The NCR-Fwd 510A is a kind of a repeater that relays a radio signal transmitted between the gNB 200 and the UE 100, to be more specific, that changes a propagation state of the radio signal without demodulating or modulating the radio signal. The NCR-MT 520A performs radio communication with the gNB 200 to control the NCR-Fwd 510A. In this manner, the NCR-MT 520A controls the NCR apparatus 500A in cooperation with the gNB 200 by establishing a radio connection to the gNB 200 and performing wireless communication with the gNB 200. By doing so, efficient coverage extension can be achieved using the NCR apparatus 500A. The NCR-MT 520A controls the NCR apparatus 500A in accordance with control from the gNB 200.

The NCR-MT 520A may be configured separately from the NCR-Fwd 510A. For example, the NCR-MT 520A may be located near the NCR-Fwd 510A and may be electrically connected to the NCR-Fwd 510A. The NCR-MT 520A may be connected to the NCR-Fwd 510A by wire or wirelessly. The NCR-MT 520A may be configured to be integrated with the NCR-Fwd 510A. The NCR-MT 520A and the NCR-Fwd 510A may be fixedly installed at a coverage edge (cell edge) of the gNB 200, or on a wall surface or window of any building, for example. The NCR-MT 520A and the NCR-Fwd 510A may be installed in, for example, a vehicle to be movable. One NCR-MT 520A may control multiple NCR-Fwds 510A.

In the example illustrated in FIG. 5, the NCR apparatus 500A (NCR-Fwd 510A) dynamically or semi-statically changes a beam for transmission or reception. For example, the NCR-Fwd 510A forms a beam toward each of a UE 100a and a UE 100b. The NCR-Fwd 510A may form a beam toward the gNB 200. For example, in a communication resource between the gNB 200 and the UE 100a, the NCR-Fwd 510A transmits a radio signal received from the gNB 200 toward the UE 100a through beamforming and/or transmits a radio signal received from the UE 100a toward the gNB 200 through beamforming. In a communication resource between the gNB 200 and the UE 100b, the NCR-Fwd 510A transmits a radio signal received from the gNB 200 toward the UE 100b through beamforming and/or transmits a radio signal received from the UE 100b toward the gNB 200 through beamforming. Instead of or in addition to the beamforming, the NCR-Fwd 510A may perform null forming (so-called null steering) toward a UE 100 which is not a communication partner (not illustrated) and/or a neighboring gNB 200 (not illustrated) to suppress the interference.

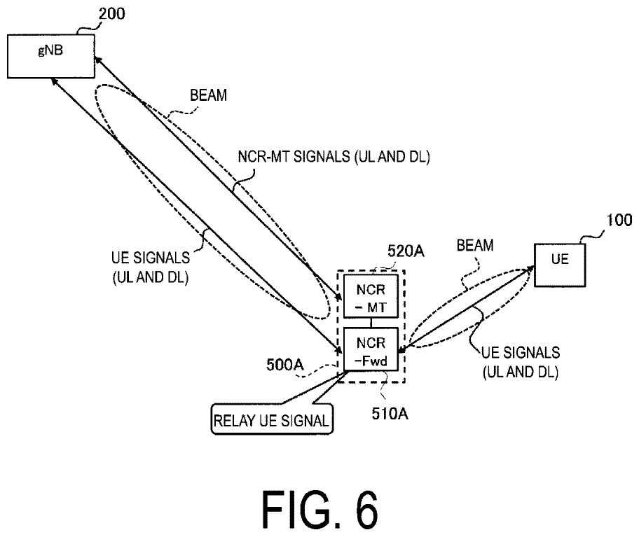

FIG. 6 is a diagram illustrating a control method of the NCR apparatus 500A according to the first embodiment. As illustrated in FIG. 6, the NCR-Fwd 510A relays a radio signal (referred to as a “UE signal”) between the gNB 200 and the UE 100. The UE signal includes an uplink signal transmitted from the UE 100 to the gNB 200 (referred to as “UE-UL signal”) and a downlink signal transmitted from the gNB 200 to the UE 100 (referred to as “UE-DL signal”). The NCR-Fwd 510A relays the UE-UL signal from the UE 100 to the gNB 200 and relays the UE-DL signal from the gNB 200 to the UE 100. A radio link between the NCR-Fwd 510A and the UE 100 is also referred to as an “access link”. A radio link between the NCR-Fwd 510A and the gNB 200 is also referred to as a “backhaul link”.

The NCR-MT 520A transmits and receives radio signals (referred to herein as “NCR-MT signals”) to and from the gNB 200. The NCR-MT signal includes an uplink signal transmitted from the NCR-MT 520A to the gNB 200 (referred to as an “NCR-MT-UL signal”) and a downlink signal transmitted from the gNB 200 to the NCR-MT 520A (referred to as an “NCR-MT-DL signal”). The NCR-MT-UL signal includes signaling for controlling the NCR apparatus 500A. A radio link between the NCR-MT 520A and the gNB 200 is also referred to as a “control link”.

The gNB 200 directs a beam to the NCR-MT 520A, based on the NCR-MT-UL signal from the NCR-MT 520A. The NCR apparatus 500A and the NCR-MT 520A are co-located, and thus directing, by the gNB 200, a beam to the NCR-MT 520A results in directing the beam also to the NCR-Fwd 510A when frequencies of the backhaul link and the control link are the same. The gNB 200 transmits the NCR-MT-DL signal and the UE-DL signal using the beam. The NCR-MT 520A receives the NCR-MT-DL signal. Note that, when the NCR-Fwd 510A and NCR-MT 520A are at least partially integrated with each other, in the NCR-Fwd 510A and NCR-MT 520A, functions of transmitting and receiving or relaying UE signals and/or NCR-MT signals (e.g., antennas) may be integrated together. The beam includes a transmission beam and/or a reception beam. The beam is a general term for transmission and/or reception under control for maximizing power of a transmission wave and/or a reception wave in a specific direction by adjusting/adapting an antenna weight or the like.

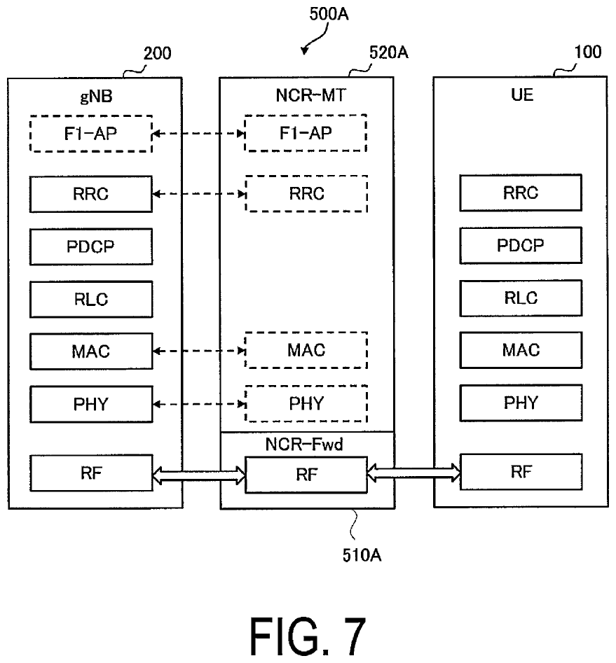

FIG. 7 is a diagram illustrating a configuration example of a protocol stack in the mobile communication system 1 that includes the NCR apparatus 500A according to the first embodiment. The NCR-Fwd 510A relays a radio signal transmitted and received between the gNB 200 and the UE 100. The NCR-Fwd 510A has a Radio Frequency (RF) function of amplifying and relaying a received radio signal, and performs directional transmission through beamforming (for example, analog beamforming).

The NCR-MT 520A includes at least one layer (entity) selected from the group consisting of PHY, MAC, RRC, and F1-AP (Application Protocol). The F1-AP is a type of a fronthaul interface. The NCR-MT 520A communicates downlink signaling and/or uplink signaling, which will be described below, with the gNB 200 through at least one selected from the group consisting of the PHY, the MAC, RRC, and the F1-AP. When the NCR-MT 520A is a type or a part of the base station, the NCR-MT 520A may communicate with the gNB 200 through an AP of Xn (Xn-AP) which is an inter-base station interface.

### (1.3) Configuration Example of Relay Apparatus

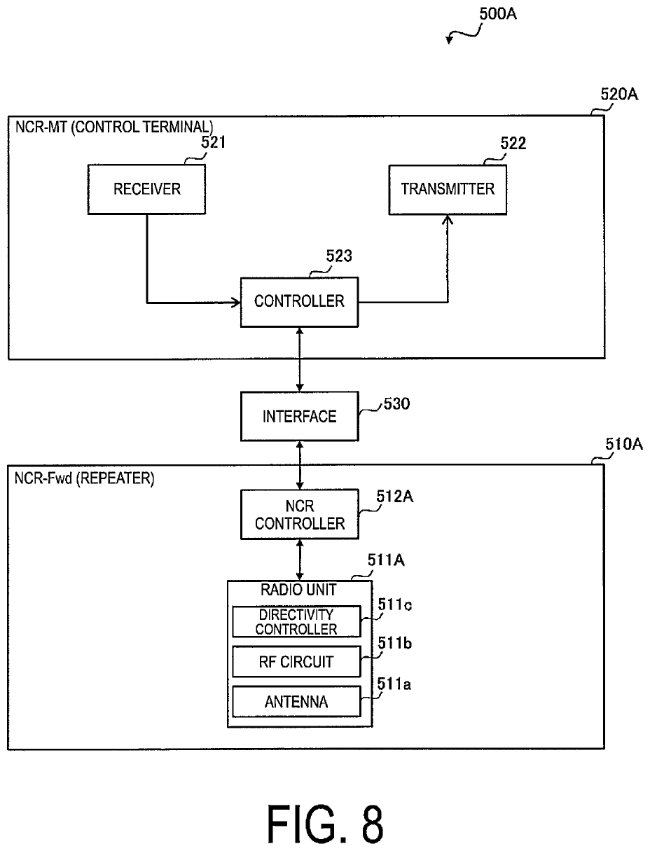

FIG. 8 is a diagram illustrating a configuration example of the NCR apparatus 500A as the relay apparatus according to the first embodiment. The NCR apparatus 500A includes the NCR-Fwd 510A, the NCR-MT 520A, and an interface 530.

The NCR-Fwd 510A includes a radio unit 511A and an NCR controller 512A. The radio unit 511A includes an antenna 511a including multiple antennas (multiple antenna elements), an RF circuit 511b including an amplifier, and a directivity controller 511c controlling directivity of the antenna 511a. The RF circuit 511b amplifies and relays (transmits) radio signals transmitted and received by the antenna 511a. The RF circuit 511b may convert a radio signal, which is an analog signal, into a digital signal, and may reconvert the digital signal into an analog signal after digital signal processing. The directivity controller 511c may perform analog beamforming by analog signal processing. The directivity controller 511c may perform digital beamforming by digital signal processing. The directivity controller 511c may perform analog and digital hybrid beamforming. The NCR controller 512A controls the radio unit 511A in response to a control signal from the NCR-MT 520A. The NCR controller 512A may include at least one processor. The NCR controller 512A may output information relating to a capability of the NCR apparatus 500A to the NCR-MT 520A.

The NCR-MT 520A includes a receiver 521, a transmitter 522, and a controller 523. The receiver 521 performs various types of reception under control of the controller 523. The receiver 521 includes an antenna and a reception device. The reception device converts a radio signal (radio signal) received through the antenna into a baseband signal (a reception signal) and outputs the resulting signal to the controller 523. The transmitter 522 performs various types of transmission under control of the controller 523. The transmitter 522 includes an antenna and a transmission device. The transmission device converts a baseband signal (a transmission signal) output by the controller 523 into a radio signal and transmits the resulting signal through the antenna. The controller 523 performs various types of controls in the NCR-MT 520A. The controller 523 includes at least one processor and at least one memory. The memory stores a program to be executed by the processor and information to be used for processing by the processor. The processor may include a baseband processor and a Central Processing Unit (CPU). The baseband processor performs modulation and demodulation, coding and decoding, and the like on a baseband signal. The CPU executes the program stored in the memory to thereby perform various types of processing. The controller 523 performs a function of at least one layer selected from the group consisting of the PHY, the MAC, the RRC, and the F1-AP.

The interface 530 electrically connects the NCR-Fwd 510A and the NCR-MT 520A. The controller 523 of the NCR-MT 520A controls the NCR-Fwd 510A via the interface 530.

In the first embodiment, the receiver 521 of the NCR-MT 520A receives signaling (downlink signaling) used to control the NCR apparatus 500A from the gNB 200 through wireless communication. The controller 523 of the NCR-MT 520A controls the NCR apparatus 500A based on the signaling. This enables the gNB 200 to control the NCR-Fwd 510A via the NCR-MT 520A.

In the first embodiment, the controller 523 of the NCR-MT 520A may transmit the NCR capability information indicating the capability of the NCR apparatus 500A to the gNB 200 through wireless communication. The NCR capability information is an example of the uplink signaling from the NCR-MT 520A to the gNB 200. This enables the gNB 200 to recognize the capability of the NCR apparatus 500A.

### (1.4) Configuration Example of Base Station

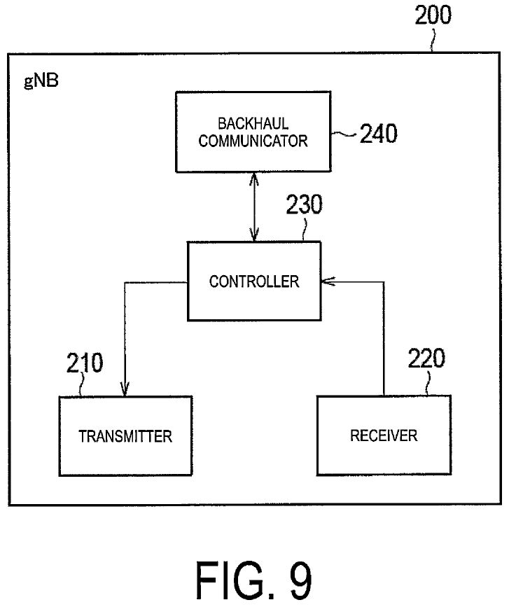

FIG. 9 is a diagram illustrating a configuration example of the gNB 200 according to the first embodiment. The gNB 200 includes a transmitter 210, a receiver 220, a controller 230, and a backhaul communicator 240.

The transmitter 210 performs various types of transmission under control of the controller 230. The transmitter 210 includes an antenna and a transmission device. The transmission device converts a baseband signal (a transmission signal) output by the controller 230 into a radio signal and transmits the resulting signal through the antenna. The receiver 220 performs various types of reception under control of the controller 230. The receiver 220 includes an antenna and a reception device. The reception device converts a radio signal received through the antenna into a baseband signal (a reception signal) and outputs the resulting signal to the controller 230. The transmitter 210 and the receiver 220 may be capable of beamforming using multiple antennas.

The controller 230 performs various types of controls for the gNB 200. The controller 230 includes at least one processor and at least one memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing.

The backhaul communicator 240 is connected to a neighboring base station via the inter-base station interface. The backhaul communicator 240 is connected to the AMF/UPF 300 via the interface between a base station and the core network. Note that the gNB may include a Central Unit (CU) and a Distributed Unit (DU) (i.e., functions are divided), and both units may be connected via an F1 interface.

In the first embodiment, the transmitter 210 of the gNB 200 transmits signaling (downlink signaling) used to control the NCR-Fwd 510A to the NCR-MT 520A through wireless communication. This enables the gNB 200 to control the NCR apparatus 500A via the NCR-MT 520A. In the first embodiment, the receiver 220 of the gNB 200 may receive the NCR capability information indicating the capability of the NCR apparatus 500A from the NCR-MT 520A through wireless communication.

### (1.5) Example of Downlink Signaling

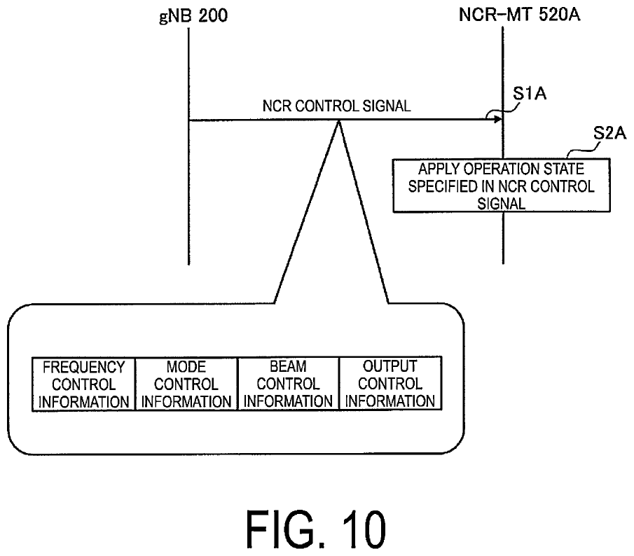

FIG. 10 is a diagram illustrating an example of the downlink signaling from the gNB 200 to the NCR-MT 520A according to the first embodiment.

The gNB 200 (transmitter 210) transmits downlink signaling to the NCR-MT 520A. The downlink signaling may be an RRC message that is RRC layer (i.e., layer-3) signaling. The downlink signaling may be a MAC Control Element (CE) that is MAC layer (i.e., layer-2) signaling. The downlink signaling may be downlink control information (DCI) that is PHY layer (i.e., layer-1) signaling. The downlink signaling may be UE-specific signaling. The downlink signaling may be broadcast signaling. The downlink signaling may be a fronthaul message (for example, F1-AP message). When the NCR-MT 520A is a type or a part of the base station, the NCR-MT 520A may communicate with the gNB 200 through an AP of Xn (Xn-AP) which is an inter-base station interface.

For example, the gNB 200 (transmitter 210) transmits an NCR control signal designating an operation state of the NCR apparatus 500A as the downlink signaling to the NCR-MT 520A having established a radio connection to the gNB 200 (step S1A). The NCR control signal designating the operation state of the NCR apparatus 500A may be the MAC CE that is the MAC layer (layer-2) signaling or the DCI that is the PHY layer (layer-1) signaling. However, the NCR control signal may be included in an RRC Reconfiguration message that is a type of a UE-specific RRC message to transmit to the NCR-MT 520A. The downlink signaling may be a message of a layer (for example, an NCR application) higher than the RRC layer. The downlink signaling may be transmitting a message of a layer higher than the RRC layer encapsulated with a message of a layer equal to or lower than the RRC layer. Note that the NCR-MT 520A (transmitter 522) may transmit a response message with respect to the downlink signaling from the gNB 200 in the uplink. The response message may be transmitted in response to the NCR apparatus 500A completing the configuration designated in the downlink signaling or receiving the configuration.

The NCR control signal may include frequency control information to designate a center frequency of a radio signal (for example, a component carrier) that is a target to be relayed by the NCR-Fwd 510A. When the NCR control signal received from the gNB 200 includes the frequency control information, the NCR-MT 520A (controller 523) controls the NCR-Fwd 510A such that the NCR-Fwd 510A relays a radio signal as the target to be relayed that has a center frequency indicated by the frequency control information (step S2A). The NCR control signal may include multiple pieces of frequency control information to designate center frequencies different from each other. Since the NCR control signal includes the frequency control information, the gNB 200 can designate the center frequency of the radio signal that is the target to be relayed by the NCR-Fwd 510A via the NCR-MT 520A.

The NCR control signal may include mode control information to designate an operation mode of the NCR-Fwd 510A. The mode control information may be associated with the frequency control information (center frequency). The operation mode may be any one of a mode in which the NCR-Fwd 510A performs non-directional transmission and/or reception, a mode in which the NCR-Fwd 510A performs fixed-directional transmission and/or reception, a mode in which the NCR-Fwd 510A performs transmission and/or reception with a variable directional beam, and a mode in which the NCR-Fwd 510A performs Multiple Input Multiple Output (MIMO) relay transmission. The operation mode may be either a beamforming mode (that is, a mode in which improvement of a desired wave is emphasized) or a null steering mode (that is, a mode in which suppression of an interference wave is emphasized). When the NCR control signal received from the gNB 200 includes the mode control information, the NCR-MT 520A (controller 523) controls the NCR-Fwd 510A such that the NCR-Fwd 510A operates in the operation mode indicated by the mode control information (step S2A). Since the NCR control signal includes the mode control information, the gNB 200 can designate the operation mode of the NCR-Fwd 510A via the NCR-MT 520A.

Here, the mode in which the NCR apparatus 500A performs non-directional transmission and/or reception is a mode in which the NCR-Fwd 510A performs relay in all directions and may be referred to as an omnidirectional mode. The mode in which the NCR-Fwd 510A performs fixed-directional transmission and/or reception may be a directivity mode realized by one directional antenna. The mode may be a beamforming mode realized by applying fixed phase and amplitude control (antenna weight control) to multiple antennas. Any of these modes may be designated (configured) from the gNB 200 to the NCR-MT 520A. The mode in which the NCR-Fwd 510A performs transmission and/or reception with a variable directional beam may be a mode for performing analog beamforming. The mode may be a mode in which hybrid beamforming is performed. The mode may be a mode in which hybrid beamforming is performed. The mode may be a mode for forming an adaptive beam specific to the UE 100. Any of these modes may be designated (configured) from the gNB 200 to the NCR-MT 520A. Note that in the operation mode in which beamforming is performed, beam control information described below may be provided from the gNB 200 to the NCR-MT 520A. The mode in which the NCR apparatus 500A performs MIMO relay transmission may be a mode for performing Single-User (SU) spatial multiplexing. The mode may be a mode for performing Multi-User (MU) spatial multiplexing. The mode may be a mode for performing transmission diversity. Any of these modes may be designated (configured) from the gNB 200 to the NCR-MT 520A. The operation mode may include a mode in which relay transmission by the NCR-Fwd 510A is turned on (activated) and a mode in which relay transmission by the NCR-Fwd 510A is turned off (deactivated). Any of these modes may be designated (configured) from the gNB 200 to the NCR-MT 520A in the NCR control signal.

The NCR control signal may include the beam control information to designate a transmission direction, a transmission weight, or a beam pattern for the NCR-Fwd 510A to perform directional transmission. The beam control information may be associated with the frequency control information (center frequency). The beam control information may include a Precoding Matrix Indicator (PMI). The beam control information may include beam forming angle information. When the NCR control signal received from the gNB 200 includes the beam control information, the NCR-MT 520A (controller 523) controls the NCR-Fwd 510A such that the NCR-Fwd 510A forms a transmission directivity (beam) indicated by the beam control information (step S2A). Since the NCR control signal includes the beam control information, the gNB 200 can control the transmission directivity of the NCR apparatus 500A via the NCR-MT 520A.

The NCR control signal may include output control information to designate a degree for the NCR-Fwd 510A to amplify a radio signal (amplification gain) or transmission power. The output control information may be information indicating a difference value (that is, a relative value) between the current amplification gain or transmission power and the target amplification gain or transmission power. When the NCR control signal received from the gNB 200 includes the output control information, the NCR-MT 520A (controller 523) controls the NCR-Fwd 510A such that the amplification gain or transmission power is changed to an amplification gain or transmission power indicated by the output control information (step S2A). The output control information may be associated with the frequency control information (center frequency). The output control information may be information to designate any one of an amplification gain, a beamforming gain, and an antenna gain of the NCR-Fwd 510A. The output control information may be information to designate the transmission power of the NCR-Fwd 510A.

When one NCR-MT 520A controls multiple NCR-Fwds 510A, the gNB 200 (transmitter 210) may transmit the NCR control signal for each of the NCR-Fwds 510A to the NCR-MT 520A. In this case, the NCR control signal may include an identifier of the corresponding NCR-Fwd 510A (NCR identifier). The NCR-MT 520A (controller 523) controlling the multiple NCR-Fwds 510A determines the NCR-Fwd 510A to which the NCR control signal received from the gNB 200 is applied, based on the NCR identifier included in the received NCR control signal. Note that the NCR identifier may be transmitted together with the NCR control signal from the NCR-MT 520A to the gNB 200 even when the NCR-MT 520A controls only one NCR-Fwd 510A.

As described above, the NCR-MT 520A (controller 523) controls the NCR-Fwd 510A based on the NCR control signal from the gNB 200. This enables the gNB 200 to control the NCR-Fwd 510A via the NCR-MT 520A.

### (1.6) Example of Uplink Signaling

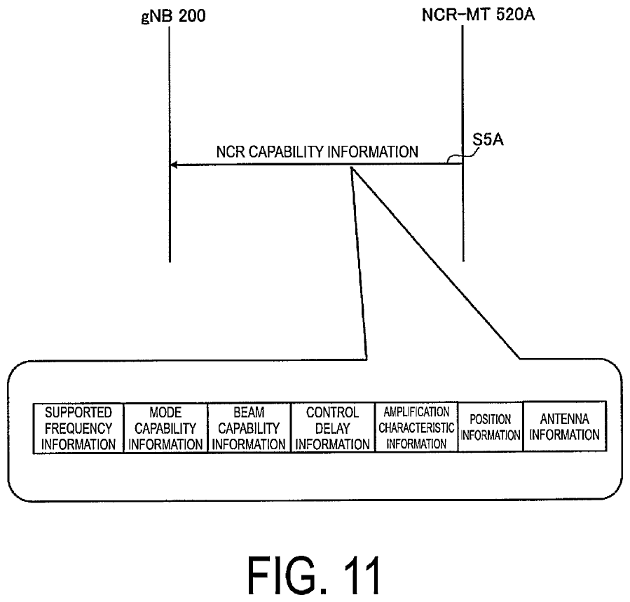

FIG. 11 is a diagram illustrating an example of the uplink signaling from the NCR-MT 520A to the gNB 200 according to the first embodiment.

The NCR-MT 520A (transmitter 210) transmits uplink signaling to the gNB 200. The uplink signaling may be an RRC message that is RRC layer signaling. The uplink signaling may be a MAC CE that is MAC layer signaling. The uplink signaling may be uplink control information (UCI) that is PHY layer signaling. The uplink signaling may be a fronthaul message (for example, F1-AP message). The uplink signaling may be an inter-base station message (for example, Xn-AP message). The uplink signaling may be a message of a layer (for example, an NCR application) higher than the RRC layer. The uplink signaling may be transmitting a message of a layer higher than the RRC layer encapsulated with a message of a layer equal to or lower than the RRC layer. That is, the uplink signaling stores a higher layer message in a lower layer container. Note that the gNB 200 (transmitter 210) may transmit a response message with respect to the uplink signaling from the NCR-MT 520A in the downlink, and the NCR-MT 520A (receiver 521) may receive the response message.

For example, the NCR-MT 520A (transmitter 522) having established a radio connection to the gNB 200 transmits the NCR capability information indicating the capability of the NCR apparatus 500A to the gNB 200 as the uplink signaling (step S5A). The NCR-MT 520A (transmitter 522) may include the NCR capability information in a UE Capability message or a UE Assistant Information message that is a type of the RRC message to transmit to the gNB 200. The NCR-MT 520A (transmitter 522) may transmit the NCR capability information (NCR capability information and/or operation state information) to the gNB 200 in response to a request or inquiry from the gNB 200.

The NCR capability information may include supported frequency information indicating a frequency supported by the NCR-Fwd 510A. The supported frequency information may be a numerical value or index indicating a center frequency of the frequency supported by the NCR-Fwd 510A. The supported frequency information may be a numerical value or index indicating a range of the frequencies supported by the NCR-Fwd 510A. When the NCR capability information received from the NCR-MT 520A includes the supported frequency information, the gNB 200 (controller 230) can recognize the frequency supported by the NCR-Fwd 510A, based on the supported frequency information. The gNB 200 (controller 230) may configure the center frequency of the radio signal that is the target to be relayed by the NCR apparatus 500A within the range of the frequencies supported by the NCR-Fwd 510A.

The NCR capability information may include mode capability information relating to the operation modes or switching between the operation modes that can be supported by the NCR-Fwd 510A. The operation mode may be, as described above, at least any one selected from the group consisting of a mode in which the NCR-Fwd 510A performs non-directional transmission and/or reception, a mode in which the NCR-Fwd 510A performs fixed-directional transmission and/or reception, a mode in which the NCR-Fwd 510A performs transmission and/or reception with a variable directional beam, and a mode in which the NCR-Fwd 510A performs Multiple Input Multiple Output (MIMO) relay transmission. The operation mode may be either a beamforming mode (that is, a mode in which improvement of a desired wave is emphasized) or a null steering mode (that is, a mode in which suppression of an interference wave is emphasized). The mode capability information may be information indicating which operation mode among these operation modes the NCR-Fwd 510A can support. The mode capability information may be information indicating between which operation modes among these operation modes the mode switching is possible. When the NCR capability information received from the NCR-MT 520A includes the mode capability information, the gNB 200 (controller 230) can recognize the operation modes and mode switching supported by the NCR-Fwd 510A, based on the mode capability information. The gNB 200 (controller 230) may configure the operation mode of the NCR-Fwd 510A within a range of the recognized operation modes and mode switching.

The NCR capability information may include the beam capability information indicating a beam variable range, a beam variable resolution, or the number of variable patterns when the NCR-Fwd 510A performs transmission and/or reception with a variable directional beam. The beam capability information may be, for example, information indicating a variable range of a beam angle with respect to the horizontal direction or the vertical direction (for example, being controllable from 30° to) 90°. The beam capability information may be information indicating an absolute angle. The beam capability information may be represented by a direction and/or an elevation angle at which a beam is directed. The beam capability information may be information indicating an angular change for each variable step (for example, horizontal 5°/step, vertical 10°/step). The beam capability information may be information indicating the number of variable steps (for example, horizontal 10 steps and vertical 20 steps). The beam capability information may be information indicating the number of variable patterns of a beam in the NCR-Fwd 510A (for example, a total of 10 patterns of beam patterns 1 to 10). When the NCR capability information received from the NCR-MT 520A includes the beam capability information, the gNB 200 (controller 230) can recognize the beam angle change or beam patterns that can be supported by the NCR-Fwd 510A, based on the beam capability information. The gNB 200 (controller 230) may configure a beam of the NCR-Fwd 510A within a range of the recognized beam angle change or beam patterns. These pieces of beam capability information may be null capability information. For the null capability information, these pieces of beam capability information indicate a null control capability when null steering is performed.

The NCR capability information may include control delay information indicating a control delay time in the NCR apparatus 500A. For example, the control delay information is information indicating a delay time (for example, 1 ms, 10 ms . . . ) from a timing at which the UE 100 receives an NCR control signal or a timing at which the UE 100 transmits configuration completion for the NCR control signal to the gNB 200 until the UE 100 completes control (change of the operation mode and/or change of the beam) according to the NCR control signal. When the NCR capability information received from the NCR-MT 520A includes the control delay information, the gNB 200 (controller 230) can recognize the control delay time in the NCR-Fwd 510A, based on the control delay information.

The NCR capability information may include amplification characteristic information relating to radio signal amplification characteristics or output power characteristics in the NCR-Fwd 510A. The amplification characteristic information may be information indicating an amplifier gain (dB), a beamforming gain (dB), and an antenna gain (dBi) of the NCR-Fwd 510A. The amplification characteristic information may be information indicating an amplification variable range (for example, 0 dB to 60 dB) in the NCR-Fwd 510A. The amplification characteristic information may be information indicating the number of steps (for example, 10 steps) of the amplification degrees that can be changed by the NCR-Fwd 510A or the amplification degree for each variable step (for example, 10 dB/step). The amplification characteristic information may be information indicating an output power variable range (for example, 0 dBm to 30 dBm) of the NCR-Fwd 510A. The amplification characteristic information may be information indicating the number of steps (for example, 10 steps) of the output power that can be changed by the NCR-Fwd 510A or the output power for each variable step (for example, 10 dBm/step or 10 dB/step).

The NCR capability information may include position information indicating an installation location of the NCR apparatus 500A. The position information may include any one or more of latitude, longitude, and altitude. The position information may include information indicating a distance and/or an installation angle of the NCR apparatus 500A with respect to the gNB 200. The installation angle may be a relative angle with respect to the gNB 200, or a relative angle with respect to, for example, north, vertical, or horizontal. The installation location may be position information of a place where the antenna 511a of the NCR-Fwd 510A is installed.

The NCR capability information may include antenna information indicating the number of antennas included in the NCR-Fwd 510A. The antenna information may be information indicating the number of antenna ports included in the NCR-Fwd 510A. The antenna information may be information indicating a degree of freedom of the directivity control (beam or null formation). The degree of freedom indicates how many beams can be formed (controlled) and is usually “(the number of antennas)−1”. For example, in the case of two antennas, the degree of freedom is one. In the case of two antennas, an 8-shaped beam pattern is formed, but the directivity control can be performed only in one direction, so that the degree of freedom is one.

When the NCR-MT 520A controls multiple NCR-Fwds 510A, the NCR-MT 520A (transmitter 522) may transmit the NCR capability information for each NCR-Fwd 510A to the gNB 200. In this case, the NCR capability information may include the number of NCR-Fwds 510A and/or identifiers of the corresponding NCR-Fwds 510A (NCR identifiers). When the NCR-MT 520A controls multiple NCR-Fwds 510A, the NCR-MT 520A (transmitter 522) may transmit information indicating the respective identifiers of the multiple NCR-Fwds 510A and/or the number of the multiple NCR-Fwds 510A. Note that the NCR identifier may be transmitted together with the NCR capability information from the NCR-MT 520A to the gNB 200 even when the NCR-MT 520A controls only one NCR-Fwd 510A.

### (1.7) Example of General Operation Sequence

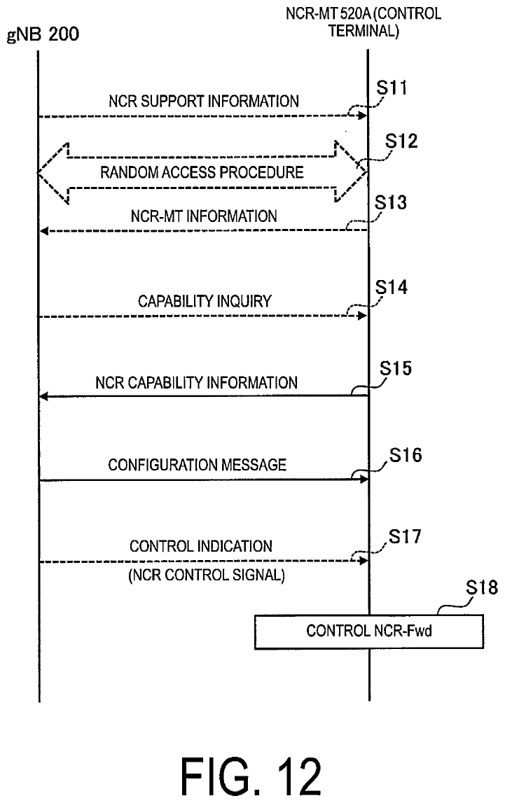

FIG. 12 is a diagram illustrating an example of a general operation sequence of the mobile communication system 1 according to the first embodiment. In the sequence diagram referred to in the embodiment described below, dashed lines indicate non-essential steps. Note that although description in detail will be given below, “NCR” in FIG. 12 may be interpreted as “RIS”.

In step S11, the gNB 200 (transmitter 210) broadcasts NCR support information indicating that the gNB 200 supports the NCR-MT 520A. For example, the gNB 200 (transmitter 210) broadcasts a system information block (SIB) including the NCR support information. The NCR support information may be information indicating that the NCR-MT 520A is accessible. The gNB 200 (transmitter 210) may broadcast NCR non-support information indicating that the gNB 200 does not support the NCR-MT 520A. The NCR non-support information may be information indicating that the NCR-MT 520A is inaccessible. In this stage, the NCR-MT 520A may be in the RRC idle state or RRC inactive state.

The NCR-MT 520A (controller 523) having not established a radio connection to the gNB 200 may determine that access to the gNB 200 is permitted in response to receiving the NCR support information from the gNB 200, and may perform an access operation to establish a radio connection to the gNB 200. The NCR-MT 520A (controller 523) may regard the gNB 200 (cell) to which access is permitted as the highest priority and perform cell reselection.

On the other hand, when the gNB 200 does not broadcast the NCR support information (or when the gNB 200 broadcasts the NCR non-support information), the NCR-MT 520A (controller 523) having not established a radio connection to the gNB 200 may determine that access (connection establishment) to the gNB 200 is not possible. This enables the NCR-MT 520A to establish a radio connection only to the gNB 200 capable of handling the NCR-MT 520A.

Note that when the gNB 200 is congested, the gNB 200 may broadcast access restriction information to restrict an access from the UE 100. However, unlike a normal UE 100, the NCR-MT 520A can be regarded as a network-side entity. Therefore, the NCR-MT 520A may disregard the access restriction information from the gNB 200. For example, the NCR-MT 520A (controller 523), when receiving the NCR support information from the gNB 200, may perform an operation to establish a radio connection to the gNB 200 even if the gNB 200 broadcasts the access restriction information. For example, the NCR-MT 520A (controller 523) may not need to perform (or may disregard) Unified Access Control (UAC). Alternatively, any one or both of Access Category/Access Identity (AC/AI) used in the UAC may be a special value indicating that the access is made by the NCR-MT.

In step S12, the NCR-MT 520A (controller 523) initiates a random access procedure for the gNB 200. In the random access procedure, the NCR-MT 520A (transmitter 522) transmits a random access preamble (Msg1) and an RRC message (Msg3) to the gNB 200. In the random access procedure, the NCR-MT 520A (receiver 521) receives a random access response (Msg2) and an RRC message (Msg4) from the gNB 200.

In step S13, when establishing a radio connection to the gNB 200, the NCR-MT 520A (transmitter 522) may transmit to the gNB 200 NCR-MT information indicating that the NCR-MT 520A itself is an NCR-MT. For example, the NCR-MT 520A (transmitter 522), during the random access procedure with the gNB 200, includes the NCR-MT information in the message (for example, Msg1, Msg3, Msg5) for the random access procedure to transmit to the gNB 200. The gNB 200 (controller 230) can recognize that the accessing UE 100 is the NCR-MT 520A, based on the NCR-MT information received from the NCR-MT 520A, and exclude from the access restriction target (in other words, accept the access from), for example, the NCR-MT 520A. When the random access procedure is completed, the NCR-MT 520A transitions from the RRC idle state or the RRC inactive state to the RRC connected state.

In step S14, the gNB 200 (transmitter 522) transmits a capability inquiry message to inquire the capability of the NCR-MT 520A to the NCR-MT 520A. The NCR-MT 520A (receiver 521) receives the capability inquiry message.

In step S15, the NCR-MT 520A (transmitter 522) transmits a capability information message including the NCR capability information to the gNB 200. The capability information message may be an RRC message, for example, a UE Capability message. The gNB 200 (receiver 220) receives the capability information message. The gNB 200 (controller 230) recognizes the capability of the NCR apparatus 500A based on the received capability information message.

In step S16, the gNB 200 (transmitter 522) transmits a configuration message including various configurations regarding the NCR apparatus 500A to the NCR-MT 520A. The NCR-MT 520A (receiver 521) receives the configuration message. The configuration message is a type of the above-described downlink signaling. The configuration message may be an RRC message, for example an RRC reconfiguration message.

In step S17, the gNB 200 (transmitter 522) transmits the control indication designating the operation state of the NCR-Fwd 510A to the NCR-MT 520A. The control indication may be the NCR control signal (for example, L1/L2 signaling) described above. The NCR-MT 520A (receiver 521) receives the control indication. The NCR-MT 520A (controller 523) controls the NCR-Fwd 510A in response to the control indication.

In step S18, the NCR-MT 520A controls the NCR apparatus 500A according to the configuration (and control indication). The NCR-MT 520A may autonomously control the NCR apparatus 500A without depending on the control indication from the gNB 200. For example, the NCR-MT 520A may autonomously control the NCR apparatus 500A based on a position of the UE 100 and/or information received from the UE 100 by the NCR-MT 520A.

### (1.8) Beam Sweeping

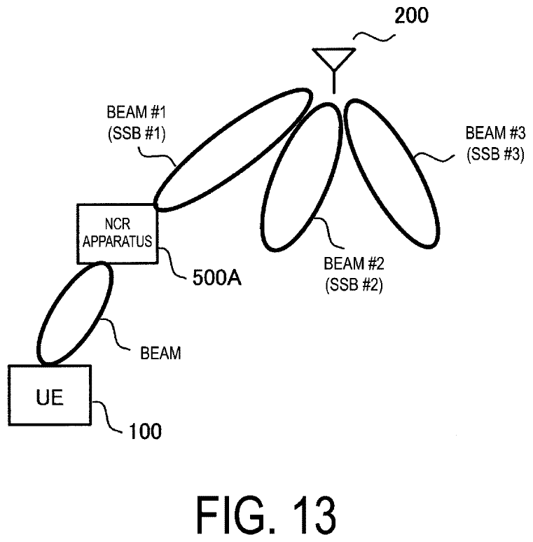

FIG. 13 is a diagram for describing beam sweeping according to the embodiment.

The gNB 200 performs beam sweeping in which transmission is performed while sequentially switching beams in different directions. At this time, the gNB 200 transmits a different SSB for each beam. The SSB is periodically transmitted from the gNB 200 into the cell as an SSB burst including multiple SSBs. An SSB index, which is an identifier, is assigned to each of the multiple SSBs in one SSB burst. The SSBs are beamformed and transmitted in different directions. The NCR apparatus 500A (NCR-MT 520A) reports, to the gNB 200 during a Random Access Channel (RACH) procedure, in which direction the beam had a good reception quality. Specifically, the NCR apparatus 500A (NCR-MT 520A) transmits a random access preamble to the gNB 200 at a random access channel (RACH) occasion associated with the SSB index of which the beam had a good reception quality. As a result, the gNB 200 can recognize the optimum beam for the NCR apparatus 500A (NCR-MT 520A).

Such an SSB may be transmitted in the initial BWP (initial DL BWP). When the NCR apparatus 500A (NCR-MT 520A) is in the RRC connected state, a dedicated BWP may be configured and activated for the NCR apparatus 500A (NCR-MT 520A). In the dedicated BWP, a channel state information reference signal (CSI-RS) may be used as a reference signal instead of the SSB. Hereinafter, on the assumption that a beam and an SSB (specifically, an SSB index) have a one-to-one relationship, an example in which beam information for identifying a beam is an SSB index will be mainly described. However, the beam may be associated with the CSI-RS. The beam information for identifying a beam may be a CSI-RS index.

### (1.9) Beam Unit Access Restriction

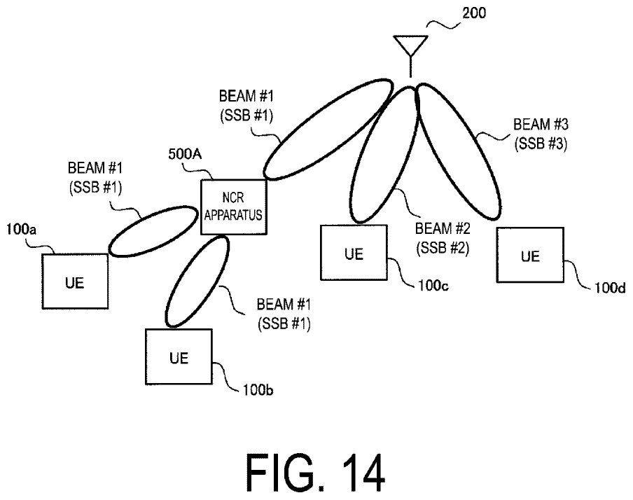

FIG. 14 is a diagram for describing beam unit access restriction according to an embodiment.

Installing the NCR apparatus 500A in a cell allows the coverage of the cell to be extended by the NCR apparatus 500A. This may increase the number of UE 100 accommodated in the cell, congest the cell, and make resources of the cell tight.

In the example of FIG. 14, the NCR apparatus 500A (NCR-Fwd 510A) performs relay transmission for a beam #1 formed by the gNB 200. The beam #1 is associated with an SSB #1 (where “#1” represents the SSB index). The UEs 100a and 100b receive the beam #1 formed by the NCR apparatus 500A (NCR-Fwd 510A). A UE 100c receives a beam #2 associated with an SSB #2. The UE 100c receives a beam #3 associated with an SSB #3.

Here, specifications are defined for access restriction as a mechanism for restricting access of the gNB 200 to the cell when a load on the gNB 200 increases. In general access restriction, the gNB 200 sets a parameter (cellBarred) in a master information block (MIB) broadcast in the cell of the gNB 200 to a value indicating access barred. When the UE 100 in an RRC idle state or an RRC inactive state finds a cell that broadcasts such an MIB, the UE 100 determines that access (random access) to the cell is prohibited, and searches for another cell. In such a general access restriction, a problem exists in that access of every UE 100 is restricted.

In the example of FIG. 14, the gNB 200 performing control to turn off the NCR apparatus 500A may reduce the load on the gNB 200. However, the UEs 100a and 100b that have already been connected need to perform beam recovery and the like, and cannot perform communication when a beam cannot be found, which is a problem. The embodiment makes it possible to perform access restriction on a per beam basis. This allows detailed access restriction to be performed.

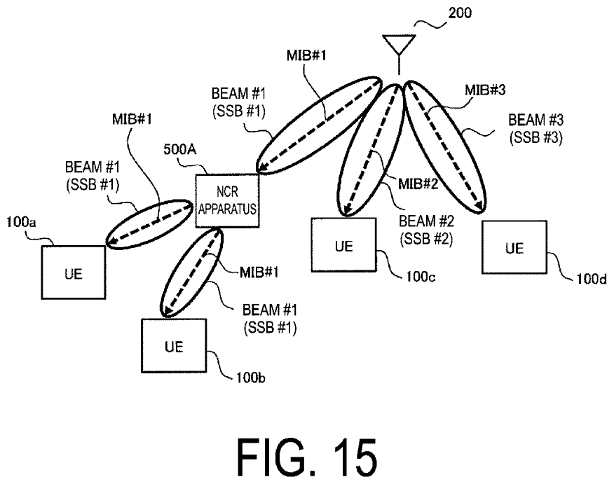

FIG. 15 is a diagram illustrating an example of the beam unit access restriction according to an embodiment.

In the embodiment, the gNB 200 forms multiple beams in one cell by beam sweeping. When the access restriction is targeted to only some of the multiple beams, the gNB 200 broadcasts, in the some beams, first information indicating that the access restriction is performed on a per beam basis. This makes it possible to perform access restriction on a per beam basis rather than a per cell basis.

The first information is information defined separately from second information (cellBarred) indicating whether the access restriction on a per cell basis is performed. For example, the first information is 1-bit information which is set to a first value (for example, “1”) when the access restriction on a per beam basis is performed, and set to a second value (for example, “0”) when the access restriction on a per beam basis is not performed. The first information is also referred to as “beamBarred”, the first value is also referred to as “barred”, and the second value is also referred to as “notBarred”.

For example, the gNB 200 transmits the MIB including information indicating the first information (beamBarred). Since the SSB includes the MIB, the UE 100 that has received the beam (SSB) can recognize accessibility of the beam based on the first information (beamBarred) in the MIB included in the beam (SSB).

The gNB 200 may transmit, in the beam targeted for access restriction, the MIB including the first information (beamBarred) set to barred and the second information indicating that access restriction on a per cell basis is not performed. As a result, the UE 100 that has received the MIB in the beam of the cell can recognize that access to the cell is not restricted but access to the beam is restricted and search for another beam of the cell.

The second information (cellBarred) is general access restriction information. For example, the second information is 1-bit information which is set to a first value (for example, “1”) when the access restriction on a per cell basis is performed, and set to a second value (for example, “0”) when the access restriction on a per cell basis is not performed. The second information is also referred to as “cellBarred”, the first value is also referred to as “barred”, and the second value is also referred to as “notBarred”.

When the gNB 200 subjects the cell as a whole to the access restriction, the gNB 200 may broadcast second information indicating that the access restriction on a per cell basis is performed in multiple beams. For example, the gNB 200 may transmit the MIB including cellBarred set to barred in all beams of the cell of the gNB 200.

The NCR apparatus 500A that performs relay transmission of the beam to which access is restricted transfers the first information (beamBarred) from the gNB 200. As a result, the UE 100 that receives the beam formed by the NCR apparatus 500A can recognize accessibility of the beam based on the first information (beamBarred) received from the NCR apparatus 500A.

Note that the NCR apparatus 500A (NCR-MT 520A) may be permitted to access the gNB 200 regardless of cellBarred and beamBarred. That is, the NCR apparatus 500A (NCR-MT 520A) may be able to disregard cellBarred and beamBarred. For example, the NCR apparatus 500A (NCR-MT 520A) may be permitted to access the gNB 200 even when receiving cellBarred set to barred or beamBarred set to barred from the gNB 200.

Although the NCR apparatus 500A (NCR-MT 520A) may be able to disregard cellBarred, beamBarred may be applied. For example, the NCR apparatus 500A (NCR-MT 520A), when receiving beamBarred set to barred from the gNB 200, may be prohibited from accessing the gNB 200.

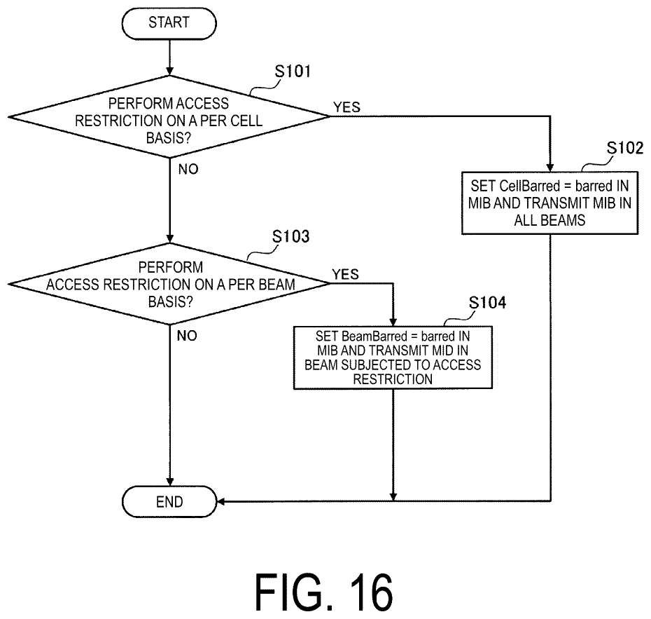

FIG. 16 is a diagram illustrating an operation example of the gNB 200 for the beam unit access restriction

In step S101, the gNB 200 that forms multiple beams in the cell of the gNB 200 determines whether to perform access restriction on a per cell basis. When the access restriction on a per cell basis is determined to be performed (step S101: YES), in step S102, the gNB 200 transmits the MIB including cellBarred set to barred in all beams of the cell of the gNB 200.

When the access restriction on a per cell basis is determined to not be performed (step S101: NO), in step S103, the gNB 200 determines whether to perform access restriction on a per beam basis, that is, access restriction on a specific beam of multiple beams of the cell of the gNB 200. When the access restriction on a per beam basis is determined to be performed (step S103: YES), in step S104, the gNB 200 transmits the MIB including beamBarred set to barred only in the specific beam.

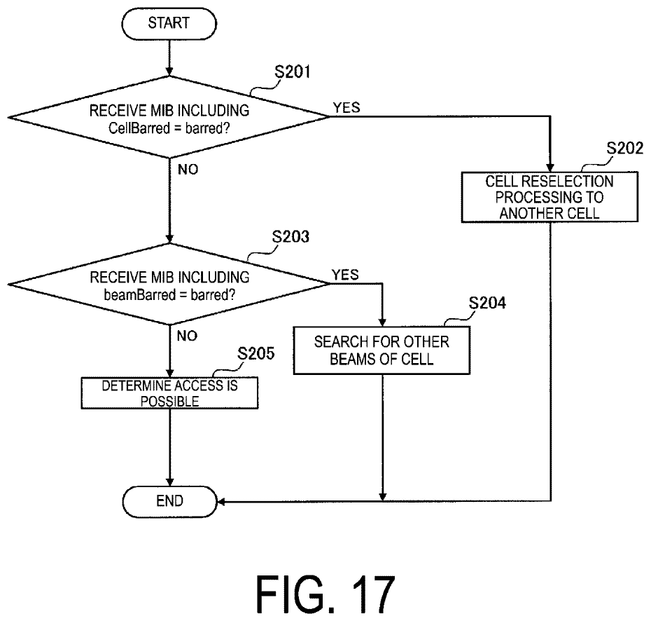

FIG. 17 is a diagram illustrating an operation example of the UE 100 for the beam unit access restriction. Here, the UE 100 may be in the RRC idle state or RRC inactive state.

In step S201, the UE 100 that receives the MIB transmitted in the beam of the cell determines whether the MIB including cellBarred set to barred has been received. When the MIB including cellBarred set to barred is determined to have been received (step S201: YES), in step S202, the UE 100 determines that the UE 100 is prohibited from accessing the cell, and performs cell reselection processing to another cell.

On the other hand, when the MIB including cellBarred set to notBarred is determined to have been received (step S201: NO), in step S203, the UE 100 determines whether the MIB including beamBarred set to barred has been received. When the MIB including beamBarred set to barred is determined to have been received (step S203: YES), in step S204, the UE 100 determines that the UE 100 is prohibited from accessing the beam, and performs processing of searching for another beam of the cell. That is, the UE 100 refrains from accessing via the SSB including the MIB indicating the access prohibition. Here, the UE 100 may exclude the relevant beam (SSB) from candidates and search for another beam (SSB). The UE 100 may be prohibited from access only for a certain period of time after receiving the MIB. The certain period of time may be broadcast in the SIB or the like from the gNB 200. The certain period of time may be defined in advance in system specifications. In this case, the UE 100 may receive the beam (SSB) again after the certain period of time elapses and determine the accessibility.

When the MIB including beamBarred set to notBarred is determined to have been received (step S203: NO), in step S205, the UE 100 determines that the UE 100 can access the gNB 200 via the beam (SSB).

Note that although an example is described above in which beamBarred is added to the MIB, beamBarred may be added to, for example, SIB type 1 (SIB1). For example, the gNB 200 may set “beamBarred=barred” in the SIB1 transmitted in a beam in the direction of NCR apparatus 500A and set “beamBarred=notBarred” in the SIB1 transmitted in beams in other directions.

### (1.10) Inter-Cell Cooperative Operation

When assumed that the NCR apparatus 500A is installed at a cell edge, the NCR apparatus 500A may be a source of interference to neighboring cells. In the embodiment, a first network node managing a first cell controls the NCR apparatus 500A (relay apparatus) relaying a radio signal between the first network node and the UE 100 in the first cell. The first network node communicates control state information regarding the control state of the NCR apparatus 500A with a second network node managing a second cell adjacent to the first cell. As a result, the cells can cooperate with each other, and the interferences caused by the NCR apparatus 500A can be kept from occurring.

The first network node may be a first DU connected to the CU. The second network node may be a second DU connected to the CU. The first DU may communicate the control state information with the second DU via the CU.

The first network node may be a first gNB. The second network node may be a second gNB connected to the first gNB via an inter-base station interface (Xn interface). The first gNB may communicate the control state information with the second DU via the Xn interface.

The first network node may notify the second network node of the control state information indicating the control state of the NCR apparatus 500A controlled by the first network node. The second network node, prior to the notification, may make an inquiry to the first network node to request the notification of the control state information.

The second network node may notify the first network node of the control state information indicating the control state of the NCR apparatus 500A, the control state information being desired by the second network node.

### (1.10.1) First Operation Example of Inter-Cell Cooperative Operation

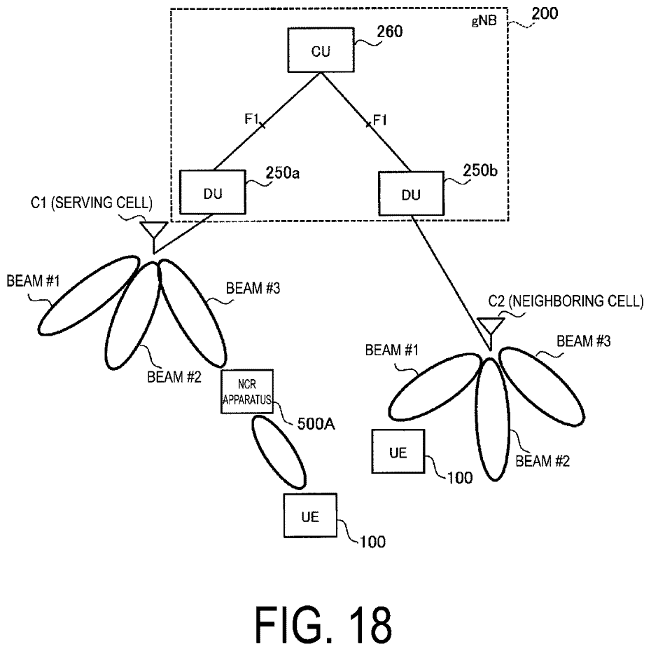

FIG. 18 is a diagram for describing a first operation example of an inter-cell cooperative operation according to an embodiment. In the first operation example, the first network node is a DU 250a (first DU) and the second network node is a DU 250b (second DU). The DU 250a (first DU) communicates the control state information of the NCR apparatus 500A with the DU 250b (second DU) via a CU 260.

In the example of FIG. 18, the NCR apparatus 500A installed at a cell edge of a cell C1 may be an interference source to a cell C2. Here, assuming that the gNB 200 is functionally divided into the DU 250 (two DUs 250a and 250b in the illustrated example) and the CU 260 and that the NCR apparatus 500A is controlled by the gNB 200 by way of the DCI or MAC CE, the DU 250a is considered to actually control the NCR apparatus 500A. Note that since the RRC connection of the NCR apparatus 500A (NCR-MT 520A) is terminated at the CU 260, the RRC measurement report of the NCR apparatus 500A (NCR-MT 520A) and the like are managed by the CU 260.

The cell C1 is managed by the DU 250a, the cell C2 is managed by the DU 250b, and the DUs 250a and 250b are managed by the identical CU 260. That is, the DUs 250a and 250b, and the CU 260 constitute the gNB 200. Each of the DUs 250a and 250b is connected to the CU 260 via the F1 interface. Since the NCR apparatus 500A is installed at the cell edge of the cell C1, the cell C1 is the serving cell of the NCR apparatus 500A (NCR-MT 520A). The NCR apparatus 500A relays a radio signal transmitted and received between the cell C1 (DU 250a) and the UE 100.

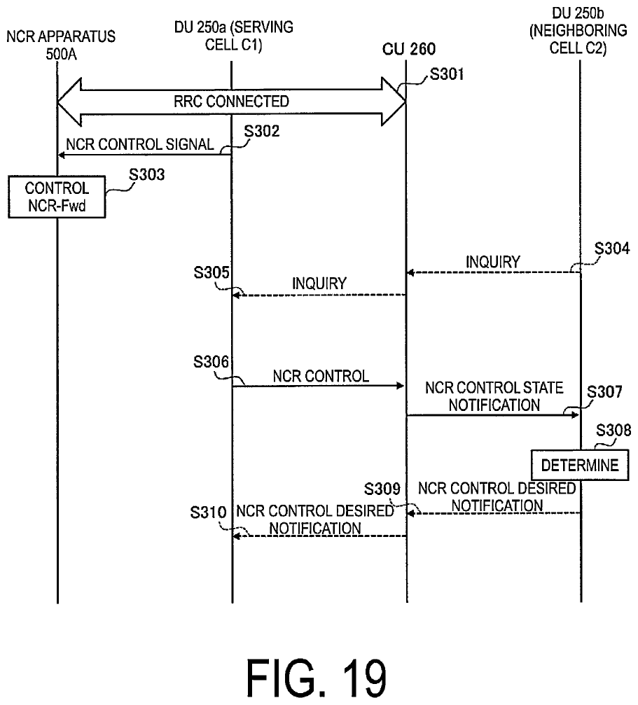

FIG. 19 is a diagram illustrating the first operation example of the inter-cell cooperative operation according to an embodiment. The NCR apparatus 500A (NCR-MT 520A) establishes an RRC connection with the CU 260 via the DU 250a (serving cell) (step S301). In the diagram referred to in the embodiment described below, dashed lines indicate non-essential steps.

In step S302, the DU 250a initiates control on the NCR apparatus 500A. The control on the NCR apparatus 500A is performed through the above-mentioned NCR control signal. In step S303, the NCR-MT 520A of the NCR apparatus 500A controls the NCR-Fwd 510A in accordance with an NCR control signal received from the DU 250a.

In step S304, the DU 250b may make an inquiry to the CU 260 over the F1 interface as to whether a connection of the NCR apparatus 500A exists. The inquiry may include a cell ID of the cell C2 managed by the DU 250b. The cell ID is used for the CU 260 to perform neighboring cell determination. The inquiry may include an RSRP threshold for the CU 260 to perform neighboring cell determination.

In step S305, the CU 260 may make an inquiry to the DU 250a as to whether a connection of the NCR apparatus 500A exists. The CU 260 may notify the DU 250a of an identifier of the NCR apparatus 500A required for reporting the control state information. The CU 260 may determine whether the NCR apparatus 500A (NCR-MT 520A) is at the cell edge of the cell C1 based on the serving cell measurement result included in the RRC measurement report from the NCR apparatus 500A. The CU 260 may determine which neighboring cell the NCR apparatus 500A is close to, based on the neighboring cell measurement result included in the RRC measurement report.

In step S306, the DU 250a transmits a notification including information indicating the control state of the NCR apparatus 500A (control state information) to the CU 260 over the F1 interface. For example, the control state information includes at least one selected from the group consisting of an SSB index of a beam relayed by the NCR apparatus 500A, a control value (transmission weight or the like) of the NCR apparatus 500A, and a cell ID of the serving cell C1 to which the NCR apparatus 500A is connected. The control value of the NCR apparatus 500A is a control value corresponding to the above-described NCR control signal, and may be a control value for each slot. The control value may be a current control value.

In step S307, the CU 260 transmits the notification including the control state information from the DU 250a to the DU 250b over the F1 interface. The notification may include the identifier of the NCR apparatus 500A and/or the cell ID of the serving cell C1 associated with the control state information.

In step S308, the DU 250b determines an influence of interference of the NCR apparatus 500A based on the control state information from the CU 260 and communication qualities of the cell C2 of the DU 250b.

In step S309, the DU 250b may transmit a notification including information (control state information) indicating the control state to the CU 260 over the F1 interface, the information being desired or not being desired for the NCR apparatus 500A. The control state information may be information of a recommended or non-recommended transmission weight (beam, SSB index, or angle). The control state information may be ON/OFF of the relay transmission. The control state information may be a desired value of the transmission power (the transmission power is desired to be reduced or how many dB is desired to be reduced). The notification may include at least one selected from the group consisting of timing information (slot number or the like), an identifier of the NCR apparatus 500A, and a cell ID of the serving cell C1 associated with the control state information.

In step S310, the CU 260 may transmit the notification including the control desired information from the DU 250a to the DU 250b over the F1 interface.

### (1.10.2) Second Operation Example of Inter-Cell Cooperative Operation

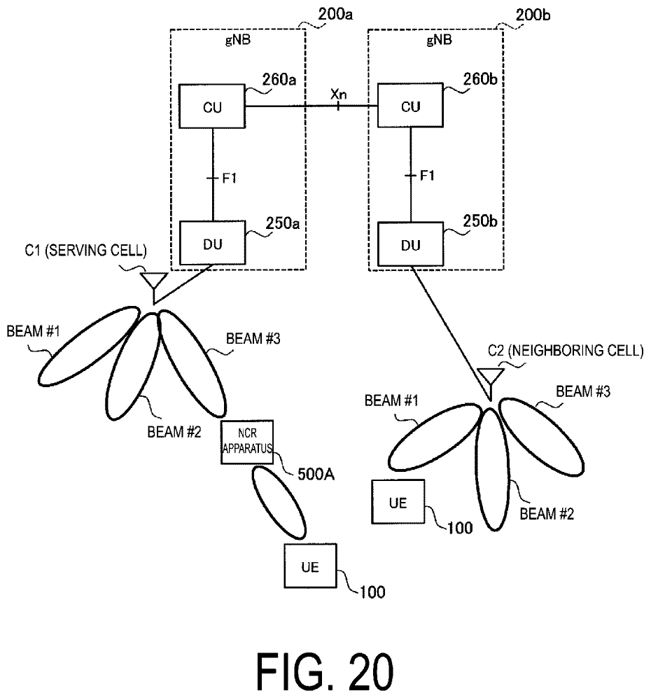

FIG. 20 is a diagram for describing a second operation example of the inter-cell cooperative operation according to an embodiment. In the second operation example, the first network node is a gNB 200a (first gNB) and the second network node is a gNB 200b (second gNB). The gNB 200a (first gNB) communicates the control state information with the gNB 200b (second gNB) via the Xn interface. Although FIG. 20 illustrates an example in which the gNB 200a is functionally divided into the DU 250a and the CU 260a, and the gNB 200b is functionally divided into the DU 250b and the CU 260b, the functions may not be divided.

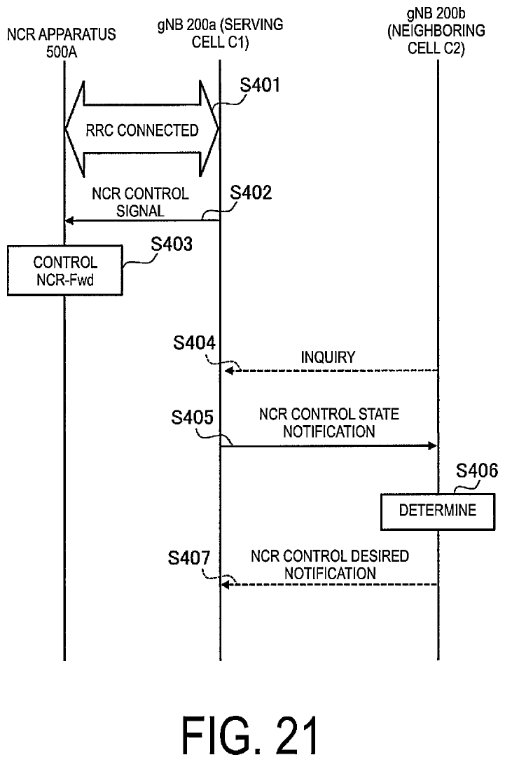

FIG. 21 is a diagram illustrating the second operation example of the inter-cell cooperative operation according to an embodiment. The NCR apparatus 500A (NCR-MT 520A) establishes an RRC connection with the gNB 200a (step S401). The description of the second operation example overlapping the first operation example described above is omitted.

In step S402, the gNB 200a initiates control on the NCR apparatus 500A. The control on the NCR apparatus 500A is performed through the above-mentioned NCR control signal. In step S403, the NCR-MT 520A of the NCR apparatus 500A controls the NCR-Fwd 510A in accordance with an NCR control signal received from the gNB 200a.

In step S404, the gNB 200b may make an inquiry to the gNB 200a as to whether a connection of the NCR apparatus 500A exists. The inquiry may include the cell ID of the cell C2 managed by the gNB 200b. The cell ID is used for the gNB 200a to perform neighboring cell determination. The inquiry may include an RSRP threshold for the gNB 200a to perform neighboring cell determination.

In step S405, the gNB 200a transmits a notification including information indicating the control state of the NCR apparatus 500A (control state information) to the gNB 200b over the Xn interface. For example, the control state information includes at least one selected from the group consisting of an SSB index of a beam relayed by the NCR apparatus 500A, a control value (transmission weight or the like) of the NCR apparatus 500A, and a cell ID of the serving cell C1 to which the NCR apparatus 500A is connected. The control value of the NCR apparatus 500A is a control value corresponding to the above-described NCR control signal, and may be a control value for each slot. The control value may be a current control value.

In step S406, the gNB 200b determines an influence of interference of the NCR apparatus 500A based on the control state information from the gNB 200a and communication qualities of the cell C2 of the gNB 200b.

In step S407, the gNB 200b may transmit a notification including information (control state information) indicating the control state to the gNB 200a over the Xn interface, the information being desired or not being desired for the NCR apparatus 500A. The control state information may be information of a recommended or non-recommended transmission weight (beam, SSB index, or angle). The control state information may be ON/OFF of the relay transmission. The control state information may be a desired value of the transmission power (the transmission power is desired to be reduced or how many dB is desired to be reduced). The notification may include at least one selected from the group consisting of timing information (slot number or the like), an identifier of the NCR apparatus 500A, and a cell ID of the serving cell C1 associated with the control state information.

### (2) Second Embodiment

With respect to a second embodiment, differences from the first embodiment described above are mainly described. The overview of a mobile communication system 1 and the configuration of a gNB 200 according to the second embodiment each are the same as and/or similar to those of the first embodiment described above.

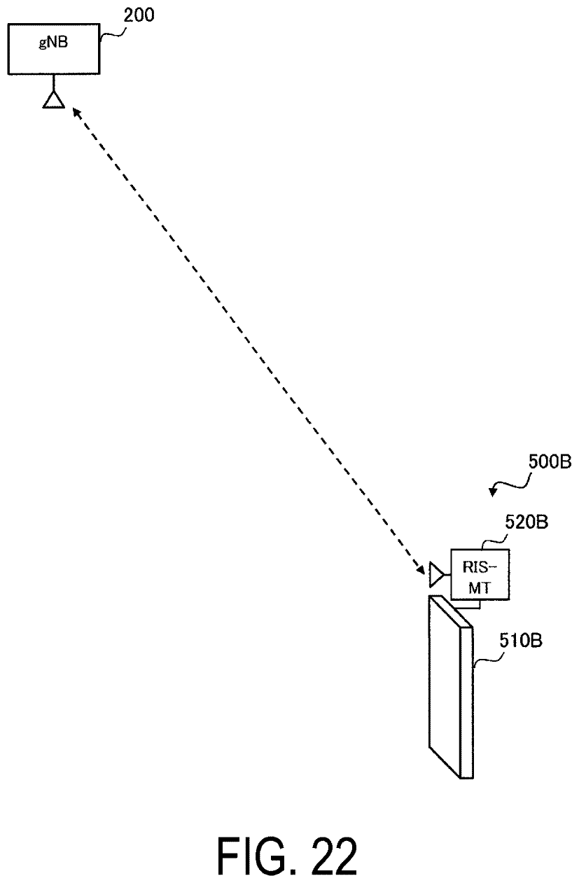

As illustrated in FIG. 22, a relay apparatus according to the second embodiment is a Reconfigurable Intelligent Surface (RIS) apparatus 500B configured to change a propagation direction of an incident radio wave (radio signal) by reflection or refraction. The “NCR” in the first and second embodiments described above may be interpreted as the “RIS”.

The RIS is a type of a repeater (hereinafter, also referred to as a “RIS-Fwd”) capable of performing beamforming (directivity control) in the same and/or similar way as the NCR by changing the characteristics of metamaterials. The RIS may be able to change a range (distance) of a beam by controlling a reflection direction and/or a refraction direction of each unit element. For example, the RIS may have a configuration capable of controlling the reflection direction and/or refraction direction of each unit element, and focusing on a near UE (directing a beam) or focusing on a far UE (directing a beam).

The RIS apparatus 500B includes a new UE (hereinafter referred to as “RIS-MT”) 520B which is a control terminal for controlling the RIS-Fwd 510B. The RIS-MT 520B controls the RIS-Fwd 510B in cooperation with the gNB 200 by establishing a radio connection to the gNB 200 and performing wireless communication with the gNB 200. The RIS-Fwd 510B may be a reflective RIS. Such a RIS-Fwd 510B reflects an incident radio wave to change the propagation direction of the radio wave. Here, a reflection angle of the radio wave can be variably configured. The RIS-Fwd 510B reflects a radio wave incident from the gNB 200 toward the UE 100. The RIS-Fwd 510B may be a transmissive RIS. Such a RIS-Fwd 510B refracts an incident radio wave to change the propagation direction of the radio wave. Here, a refraction angle of the radio wave can be variably configured.

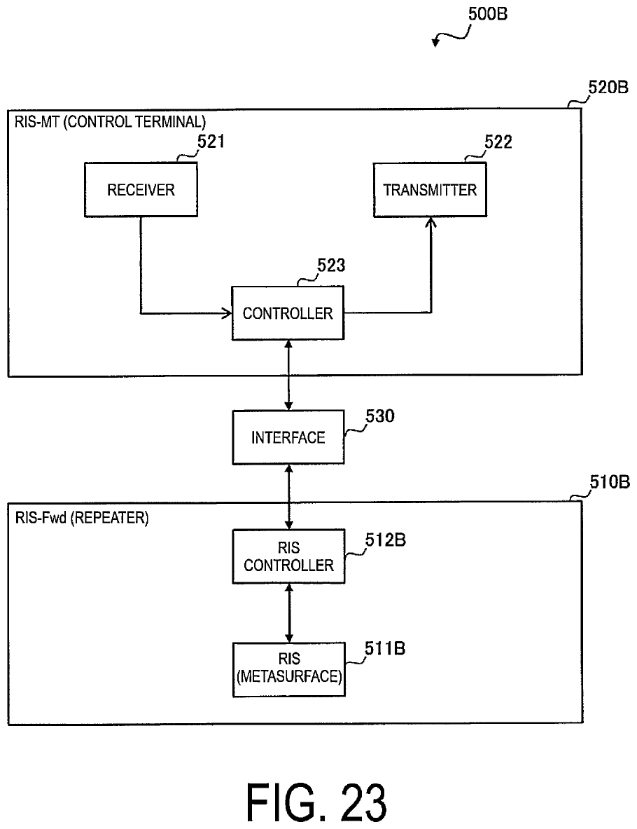

FIG. 23 is a diagram illustrating a configurations example of the RIS-Fwd 510B and the RIS-MT 520B according to the second embodiment. The RIS-MT 520B includes a receiver 521, a transmitter 522, and a controller 523. Such a configuration is the same as and/or similar to that in the first embodiment described above. The RIS-Fwd 510B includes a RIS 511B and a RIS controller 512B. The RIS 511B is a metasurface configured using metamaterials. For example, the RIS 511B is configured by installing, in an array form, structures being very small with respect to a wavelength of a radio wave, and a direction and/or a beam shape of a reflected wave is arbitrarily designed by forming the structures in different shapes depending on an installation place. The RIS 511B may be a transparent dynamic metasurface. The RIS 511B may be configured to include a transparent glass substrate stacked on a metasurface substrate on which a large number of small structures are regularly arranged and which is made transparent, and may be capable of dynamically controlling three patterns of a mode of transmitting an incident radio wave, a mode of transmitting a part of a radio wave and reflecting a part thereof, and a mode of reflecting all radio waves by minutely moving the stacked glass substrate. The RIS controller 512B controls the RIS 511B according to a RIS control signal from the controller 523 in the RIS-MT 520B. The RIS controller 512B may include at least one processor and at least one actuator. The processor interprets a RIS control signal from the controller 523 in the RIS-MT 520B to drive the actuator according to the RIS control signal.

### (3) Another Embodiments

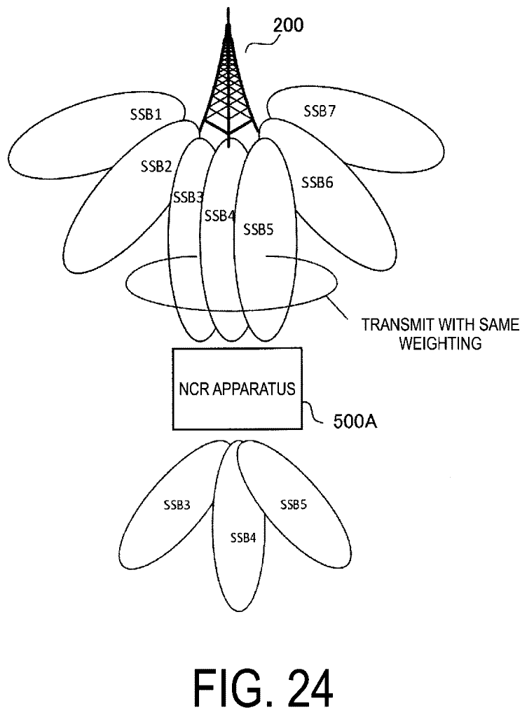

In the above-described embodiments, an example in which the gNB 200 controls the NCR apparatus 500A has been described. However, the NCR apparatus 500A (NCR-MT 520A) may autonomously control the NCR-Fwd 510A based on the configuration from the gNB 200. FIG. 24 is a diagram illustrating an example of beam sweeping according to another embodiment. The gNB 200 transmits multiple beams (beams of an SSB 3 to an SSB 5 in the illustrated example) with the same transmission weight in the direction of the NCR apparatus 500A for the backhaul link. The NCR apparatus 500A (NCR-Fwd 510A) autonomously transmits the multiple beams (beams of the SSB 3 to the SSB 5) with different transmission weights in different directions for the access link. Under such an assumption, the NCR apparatus 500A (NCR-Fwd 510A) may notify the gNB 200 of the operation state of the NCR-Fwd 510A as appropriate, and share the operation state information of the NCR-Fwd 510A with the gNB 200.

The operation flows described above can be separately and independently implemented, and also be implemented in combination of two or more of the operation flows. For example, some steps of one operation flow may be added to another operation flow or some steps of one operation flow may be replaced with some steps of another operation flow. In each flow, all steps may not be necessarily performed, and only some of the steps may be performed.

In the embodiment described above, an example in which the base station is an NR base station (i.e., a gNB) is described; however, the base station may be an LTE base station (i.e., an eNB). The base station may be a relay node such as an Integrated Access and Backhaul (IAB) node. The base station may be a Distributed Unit (DU) of the IAB node.

A program causing a computer to execute each of the processes performed by the UE 100 (NCR-MT 520A, RIS-MT 520B) or the gNB 200 may be provided. The program may be recorded on a computer readable medium. Use of the computer readable medium enables the program to be installed on a computer. Here, the computer readable medium on which the program is recorded may be a non-transitory recording medium. The non-transitory recording medium is not particularly limited, and may be, for example, a recording medium such as a CD-ROM or a DVD-ROM. Circuits for executing processing performed by the UE 100 or the gNB 200 may be integrated, and at least a part of the UE 100 or the gNB 200 may be implemented as a semiconductor integrated circuit (chipset, System on a chip (SoC)).

The phrases “based on” and “depending on/in response to” used in the present disclosure do not mean “based only on” and “only depending on/in response to,” unless specifically stated otherwise. The phrase “based on” means both “based only on” and “based at least in part on”. The phrase “depending on” means both “only depending on” and “at least partially depending on”. The terms “include”, “comprise” and variations thereof do not mean “include only items stated” but instead mean “may include only items stated” or “may include not only the items stated but also other items”. The term “or” used in the present disclosure is not intended to be “exclusive or”. Further, any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a,” “an,” and “the” are added in the present disclosure through translation, these articles include the plural unless clearly indicated otherwise in context.

Embodiments have been described above in detail with reference to the drawings, but specific configurations are not limited to those described above, and various design variation can be made without departing from the gist of the present disclosure.

### (4) Supplementary Note

Features relating to the embodiments described above are described below as supplements.

### Supplementary Note 1

A communication method for use in a mobile communication system, the communication method including:
forming, by a base station, multiple beams in one cell by beam sweeping; and
when access restriction is targeted to some of the multiple beams, broadcasting, by the base station, first information in the some of the multiple beams, the first information indicating that the access restriction is performed on a per beam basis.

### Supplementary Note 2

The communication method according to supplementary note 1, further including: when access restriction is targeted to an entirety of the cell, broadcasting, by the base station, second information in the multiple beams, the second information indicating that the access restriction is performed on a per cell basis,
wherein the first information is information defined separately from the second information.

### Supplementary Note 3

The communication method according to supplementary note 1 or 2, wherein the transmitting includes transmitting a master information block including the first information.

### Supplementary Note 4

The communication method according to supplementary note 3, wherein
the transmitting includes transmitting the master information block including the first information and second information indicating that access restriction is not performed on a per cell basis.

### Supplementary Note 5

The communication method according to any one of supplementary notes 1 to 4, further including:
transferring, by a relay apparatus configured to perform relay transmission of the some of the multiple beams, the first information from the base station.

### Supplementary Note 6

The communication method according to any one of supplementary notes 1 to 5, further including:
by a user equipment configured to receive the some of the multiple beams, refraining from accessing the some of the multiple beams and searching for another beam of the cell in response to reception of the first information.

### Supplementary Note 7

A communication method for use in a mobile communication system, the communication method including:
controlling, by a first network node configured to manage a first cell, a relay apparatus configured to relay a radio signal between the first network node and a user equipment in the first cell; and
communicating, by the first network node, control state information regarding a control state of the relay apparatus with a second network node configured to manage a second cell adjacent to the first cell.

### Supplementary Note 8

The communication method according to supplementary note 7, wherein
the first network node is a first distributed unit connected to a central unit,
the second network node is a second distributed unit connected to the central unit, and
the communicating includes communicating, by the first distributed unit, the control state information with the second distributed unit via the central unit.

### Supplementary Note 9

The communication method according to supplementary note 7, wherein
the first network node is a first base station,
the second network node is a second base station connected to the first base station via an inter-base station interface, and
the communicating includes communicating, by the first base station, the control state information with the second distributed unit via the inter-base station interface.

### Supplementary Note 10

The communication method according to any one of supplementary notes 7 to 9, wherein
the communicating includes notifying, by the first network node, the second network node of
the control state information indicating a control state of the relay apparatus controlled by the first network node.

### Supplementary Note 11

The communication method according to supplementary note 10, further including:
by the second network node to the first network node, making an inquiry to request a notification of the control state information.

### Supplementary Note 12

The communication method according to any one of supplementary notes 7 to 11, wherein
the communicating includes notifying, by the second network node, the first network node of the control state information indicating the control state of the relay apparatus, the control state information being desired or not being desired by the second network node.

### (5) Supplementary Note

### Introduction

RAN #94e has agreed on a new study item for the network-controlled repeater (NCR). The purposes of this study are as follows.

Side control information required for the network-controlled repeater is studied and defined as follows (including the assumption of maximum transmission power);
Beamforming information;
Timing information for aligning transmission and reception boundaries of the network-controlled repeater;
Information relating to UL-DL TDD configuration;
ON-OFF information for efficient interference management and energy efficiency enhancement;
Power control information for efficient interference management (as a second priority).

The L1/L2 signaling (including its configuration) for transmitting the side control information is studied and defined.

For the management of the network-controlled repeater, the following points are studied.
Identification and authorization of the network-controlled repeater.

Note 2: Adjustment with the SA3 may be necessary.

This supplementary note provides a discussion of RAN2 initial problems with respect to the NCR.

### Discussion

### NCR Model

According to the SID, scenarios and assumptions are described as follows.

The study of a NR network-controlled repeater is intended to focus on the following scenarios and assumptions.
A network-controlled repeater is an in-band RF-repeater used to extend a network coverage in the FR1 and FR2 bands. A study is underway that deployment of the FR2 may be prioritized in both outdoor to indoor O2I scenarios.
   Limiting to single-hop stationary network-controlled repeater.
   The network-controlled repeater is transparent to the UE.
   The network-controlled repeater can simultaneously maintain the link with the gNB and the link with the UE.

Note 1: Cost efficiency is an important consideration for the network-controlled repeater.

RAN1 #109e has agreed on the model of NCR as follows.

### Agreements:

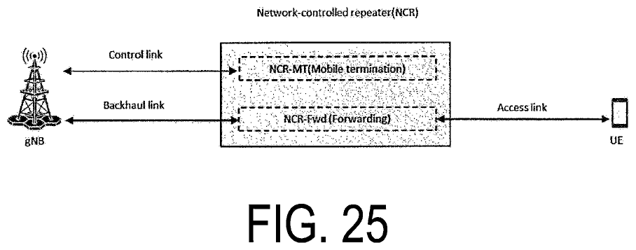

A model of the TR38.867 network-controlled repeater is illustrated in FIG. 25 and below.
The NCR-MT is defined as a functional entity that communicates with the gNB via a control link (C-link). This enables information exchange (e.g., side control information). The C-link is based on a NR Uu interface.

Note: The side control information is at least for control of the NCR-FW.
The NCR-Fwd is defined as a functional entity that amplifies and transfers the received UL/DL RF signals between gNB and UE via the backhaul link and the access link. The operation of the NCR-Fwd is controlled according to the side control information received from the gNB.

According to the above description, since the NCR-Fwd is an in-band RF-repeater, no impact on the RAN2 would be present.

Observation 1: the NCR-Fwd is an RF-repeater and is out of range of the RAN2.

On the other hand, the NCR-MT maintains a control link with the gNB and communicates the side control information. The NCR-MT may be considered as a special UE type similar to the IAB-MT. Specifically, it is natural to consider that support of protocols such as NAS, RRC, PDCP, RLC, MAC, and PHY is required. As a starting point, the IAB-MT is considered to be a good reference for modeling the NCR-MT. However, the BAP sub-layer is clearly not needed for the NCR-MT because of the assumption of “single-hop stationary network-controlled repeater only”, and control link coverage enhancement should be done by other means, such as using the FR1 or using the RF-repeaters.

Proposal 1: as a starting point, the RAN2 should consider the IAB-MT as the reference for the NCR-MT model, and the BAP sublayer is not supported in the NCR-MT.

The IAB-MT can transmit and receive its own traffic, such as OAM traffic. The same principle applies to the NCR-MT as the NCR may implement the OAM function. Therefore, the NCR-MT needs to support not only an SRB (side control information, RRC configuration, NAS connection, or the like) but also a DRB (own traffic, or the like) and the establishment of the DRB may be optional.

Proposal 2: it should be agreed that NCR-MT supports both the SRB and the DRB.

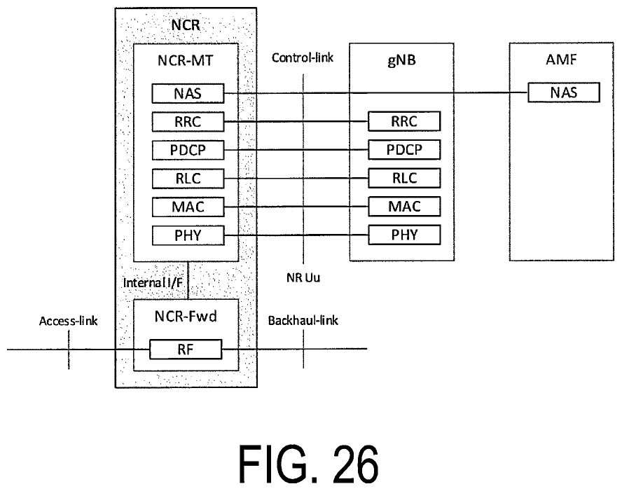

As illustrated in FIG. 26, the indication of the gNB (for example, side control information) is considered to be used by the NCR-MT to control (for example, beamforming, ON/OFF control, power control, and the like) of the NCR-Fwd via the internal interface, and whether such internal interface is designated is not a matter.

Observation 2: the NCR-MT receives an indication from the gNB (e.g., through the side control information) and controls the NCR-Fwd accordingly.

### Aspects Related to NCR Management

### Identification, Authentication, Access Control

According to the SID, the RAN2 is responsible for studying management aspects.

The following aspects related to the management of the network-controlled repeaters are studied.
Identification and authentication of the network-controlled repeaters.

Note 2: Adjustment with the SA3 may be necessary.

For the IAB-MT considered as a reference as in Proposal 1, the same access control mechanism may be applicable to the NCR-MT since the NCR is considered as a network node.
The gNB provides a SIB indication to allow NCR-MT access. This is like the IAB-Support IE in the SIB1.
The NCR-MT disregards Cell Barred IE and Intra-Freq Reselection IE of the MIB.
The NCR-MT disregards the following IEs related to reserved cells:
Cell Reserved For Future Use IE
Cell Reserved For Other Use IE (for cell barring decision)
Cell Reserved For Operator Use IE (when the NCR-MT supports NPN)
The NCR-MT transmits the NCR indication upon RRC setup completion, such as the IAB Node Indication IE.

Proposal 3: when the NCR is considered as a network node, the RAN2 should agree to reuse the access control mechanism of the IAB-MT. That is, the gNB provides the SIB indication and the NCR-MT disregards IEs related to the cell barring and the cell reservation.

When the NCR-MT is considered similar to the IAB-MT from the point of view of the RAN2, the RAN2 may assume that the higher layer mechanism of the IAB-MT is also reused for the NCR-MT. For example, it may be re-used for authentication.

Observation 3: the RAN2 can assume that the higher layer mechanisms of IAB-MT are also reused for the NCR-MT. For example, it is reuse in terms of authentication.

### NCR Capability Signal

Another problem with the management is how the gNB recognizes the functions of the NCR-Fwd such as operating frequency, the number and resolution of beamformings, and output power and dynamic range since the NCR-Fwd is an RF repeater, i.e., no protocol support is provided. The NCR-MT notifying the gNB of the capabilities of the connected NCR-Fwd in addition to its own (i.e., NCR-MT) capabilities is a very simple matter.

Proposal 4: the RAN2 should agree that the NCR-MT notifies the gNB of the capabilities of the NCR-Fwd. The capabilities to be reported are required to be further studied. Multi-Beam NCR

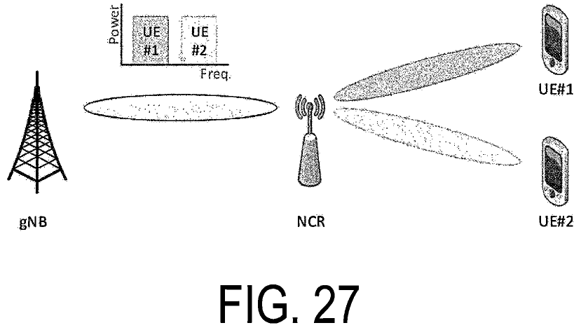

As illustrated in FIG. 27, whether the NCR can process multiple beams is also worth studying. Thus, improved spectral efficiency, enhanced coverage, and scheduling flexibility for multiple UEs are expected.

A simple RF repeater has no resource block selectivity and amplifies and transfers all signals within the system bandwidth with a single weight. On the other hand, some advanced RF repeaters may manage multiple beams for multiple UEs. Therefore, it is important that Rel-18 NCR supports such advanced RF-repeater implementations.

Proposal 5: the RAN2 should agree to manage the NCR where the gNB can process multiple beams simultaneously for different UEs.

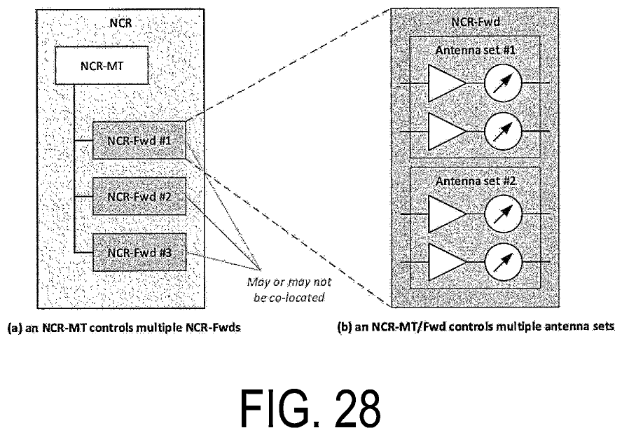

When multi-beam NCR is supported, from a RAN2 point of view, a discussion may arise as to whether one NCR node (or one NCR-MT) can support multiple NCR-Fwds. Whether one NCR-Fwd can control multiple “antenna sets” may also be additionally considered. These options are illustrated in FIG. 28.

Multiple NCR-Fwds or multiple antenna sets can process different beams for different UEs using different resource blocks within the same slot (as illustrated in FIG. 27). For multiple NCR-Fwds, the NCR needs to simultaneously process different weights indicated by the gNB for each NCR-Fwd.

As another possible scenario, the NCR may be controlled by multiple gNBs. For example, it is when the NCR is deployed at the cell edge. In this case, multiple NCR-Fwds are needed to process different beams for different access links belonging to different gNBs.

These cases may affect the management of NCRs and the design of the side control information. Therefore, the RAN2 needs to discuss a management model to allow various implementations of multi-beam NCR.

Note: the RAN1 determines whether multiple NCR-Fwds are co-located (e.g., for spatial diversity gain). Even when multiple Fwds are not co-located, the RAN1 should assume that the control link and the backhaul link share the same radio channel conditions. This is suggested by the decision at RAN #96.

Proposal 6: the RAN2 should discuss a management model of repeaters with multiple beams. For example, study whether one NCR-MT can control multiple NCR-Fwds, or whether one NCR-Fwd can support multiple antenna sets, and the like.

### Side Control Information

The RAN1 discusses the general concept and functions of the side control information, such as beam information, TDD UL/DL configuration, timing of DL reception and UL transmission, and ON-OFF information. From a RAN2 point of view, it is assumed that dynamic and semi-static controls may be indicated by DCI and MAC CE (or a combination thereof), respectively. Furthermore, static configuration should be made by RRC. For the detailed design of the side control information, the RAN2 needs to wait for the progress of the RAN1.

Observation 4: the side control information may need to extend DCI, MAC CE, and/or RRC signaling. The RAN2 needs to wait for further development of the RAN1.

### Assumption on Deployment

Although multiple frequencies support was discussed in RAN #96, the operating frequency of the control link was determined to be limited similarly to the backhaul link.

RAN chairman: the RAN1 studies will focus on in-band only.

A procedure of the control link may be intended to be simplified by exploiting the same channel conditions as the backhaul link.

Observation 5: when the control link and the backhaul link are operating at the same frequency, the radio channel conditions are the same.

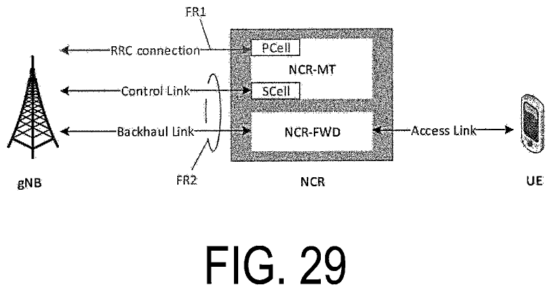

On the other hand, it is worth studying whether the NCR-MT can support carrier aggregation (CA) and dual connectivity (DC). For example, as illustrated in FIG. 29, the NCR-MT may configure the SCell (for side control information) in the FR2 at the same frequencies as the PCell (for RRC connection) in the FR1.

The NCR-MT CA/DC configuration is considered to not violate the RAN plenary decision as long as the SCell for the control link is operating at the same frequency as the NCR-Fwd for the backhaul link. Furthermore, a robust RRC connection in the FR1/PCell provides various advantages considering that the NCR is a network node. This is very similar to the CP/UP split configuration specified in the IAB.

Proposal 7: the RAN2 should study the possibility that the NCR-MT is configured with carrier aggregation (CA) or dual connectivity (DC). At least one SCell should be configured to operate at the same frequency as the NCR-Fwd.

### REFERENCE SIGNS

1: Mobile communication system
100: UE
200: gNB
210: Transmitter
220: Receiver
230: Controller
240: Backhaul communicator
500A: NCR apparatus
500B: RIS apparatus
511A: Radio unit
511a: Antenna
511b: RF circuit
511c: Directivity controller
512A: NCR controller
512B: RIS controller
521: Receiver
522: Transmitter
523: Controller
530: Interface

1. A communication method used in a mobile communication system, the communication method comprising:
broadcasting, by a base station, relay apparatus support information indicating that the base station supports a control terminal included in a relay apparatus, or access restriction information for restricting access from a user equipment;
determining, by the control terminal, that access to the base station is permitted in response to receiving the relay apparatus support information; and
ignoring, by the control terminal, the access restriction information from the base station.

2. The communication method according to claim 1, wherein
transmitting, by the control terminal, control terminal information indicating that the control terminal is the control terminal to the base station.

3. The communication method according to claim 1, wherein
supporting, by the control terminal, OAM (Operation, Administration, and Maintenance), and supporting establishing SRB (Signaling Radio Bearer) and DRB (Data Radio Bearer) with the base station.

4. A relay apparatus comprising a repeater and a control terminal in a mobile communication system, wherein
the control terminal determines that access to the base station is permitted in response to receiving, from the base station, relay apparatus support information indicating that the base station supports the control terminal; and
the control terminal ignores access restriction information from the base station for restricting access from a user equipment.

5. A system comprising a base station, a relay apparatus comprising a repeater and a control terminal, and a user equipment in a mobile communication system,
wherein the base station broadcasts relay apparatus support information indicating that the base station supports the control terminal, or access restriction information for restricting access from the user equipment;
wherein the control terminal determines that access to the base station is permitted in response to receiving the relay apparatus support information; and
wherein the control terminal ignores the access restriction information from the base station.

6. A non-transitory computer-readable medium storing instructions that, when executed by a processor of a relay apparatus comprising a repeater and a control terminal in a mobile communication system, cause the processor to perform:
processing of determining that access to the base station is permitted in response to receiving, from a base station, relay apparatus support information broadcasted indicating that the base station supports the control terminal; and
processing of ignoring access restriction information from the base station that restricts access from a user equipment.

7. A chipset for a relay apparatus comprising a repeater and a control terminal in a mobile communication system, the chipset configured to perform:
processing of determining that access to the base station is permitted in response to receiving, from a base station, relay apparatus support information broadcasted indicating that the base station supports the control terminal; and
processing of ignoring access restriction information from the base station that restricts access from a user equipment.
